(19) United States
(12) Patent Application Publication
(10) Pub. No.: US 2013/0311308 A1
(43) Pub. Date: Nov. 21, 2013

(54) CONTEXT-AWARE 3D ADVERTISEMENT SYSTEM FOR GAMES

(71) Applicant: NVIDIA CORPORATION, Santa Clara, CA (US)

(72) Inventor: Jen-Hsun Huang, Los Altos Hills, CA (US)

(73) Assignee: NVIDIA CORPORATION, Santa Clara, CA (US)

(21) Appl. No.: 13/725,583

(22) Filed: Dec. 21, 2012

Related U.S. Application Data
(60) Provisional application No. 61/647,331, filed on May 15, 2012.

(51) Int. Cl. G06Q 30/02

(52) U.S. Cl. CPC G06Q 30/0277
USPC 705/14.73

(57) ABSTRACT

Embodiments of the invention may include, in response to instructions from a software application, generating a plurality of video frames that are operable to represent a three dimensional virtual space, wherein the three dimensional virtual space comprises a shape having a surface. In addition, a supplemental texture may be applied to the surface of the shape, wherein the supplemental texture is different from an original texture instructed to be applied to the surface by the software application. Further, the plurality of video frames may be displayed, wherein the supplemental texture is rendered visible.

### CROSS-REFERENCE TO RELATED APPLICATIONS

This application claims priority to the copending Provisional U.S. Patent Application Ser. No. 61/647,331, “VIRTUALIZED GRAPHICS PROCESSING FOR REMOTE DISPLAY,” Attorney Docket NVID-P-SC-09-0210-US0, Jen-Hsun Huang, filed May 15, 2012, which is incorporated herein by reference for all purposes.

The following copending U.S. Patent Applications are incorporated herein by reference for all purposes: U.S. patent application Ser. No. ______, “VISIBILITY-BASED ADVERTISEMENT SYSTEM IN 3D VIRTUAL WORLD,” Attorney Docket NVID P-SC-09-0055-US1, Jen-Hsun Huang, filed ______; U.S. patent application Ser. No. ______, “CONTEXT-AWARE 2D ADVERTISEMENT SYSTEM FOR GAMES,” Attorney Docket NVID P-SC-09-0055-US2, Jen-Hsun Huang, filed ______; U.S. patent application Ser. No. ______, “ADVERTISEMENT SYSTEM WITH AUCTION/BIDDING FOR ADVERTISEMENT PLACEMENT OPPORTUNITIES,” Attorney Docket NVID P-SC-09-0055-US4, Jen-Hsun Huang, filed ______; and U.S. patent application Ser. No. ______, “ADVERTISEMENT SYSTEM WITH ADVERTISEMENT SELECTION RULES ENGINE,” Attorney Docket NVID P-SC-09-0055-US5, Jen-Hsun Huang, filed ______.

### BACKGROUND OF THE INVENTION

Historically, an application such as a video game was executed (played) using a personal computer (PC) or using a console attached to a television. A user purchased or rented a game, which was loaded onto the PC or inserted into the game console and then played in a well-known manner.

More recently, online gaming has become popular. An online game is played over a network such as the Internet. The game is loaded onto a user's device while other software needed to play the game resides on a server that is accessed via the network. Online gaming allows multiple users to compete against each other in the game environment provided by the software on the server.

Even more recently, cloud gaming has been gaining in popularity. Cloud gaming is a type of online gaming in which the actual game is stored on the server, in contrast to the type of online gaming mentioned above. The server executes the game in response to control information received from the user and streams the resulting content to a user's device.

Further, video games and other media may include advertisements, for example, advertisements for products and services. Such advertisements may appear in different forms. In a video game for example, an advertisement may appear on a billboard, while in a film or television show an advertisement may appear on a soda can.

### BRIEF SUMMARY OF THE INVENTION

Accordingly, embodiments of the invention provide methods and systems for including a supplemental objects or shapes in video games and other media, which may correspond to an advertisement.

Embodiments of the invention may include, in response to instructions from a software application, generating a plurality of video frames that are operable to represent a three dimensional virtual space, wherein the three dimensional virtual space comprises a shape having a surface. In addition, a supplemental texture may be applied to the surface of the shape, wherein the supplemental texture is different from an original texture instructed to be applied to the surface by the software application. Further, the plurality of video frames may be displayed, wherein the supplemental texture is rendered visible.

In some embodiments, in response to instructions from a software application, a plurality of video frames that are operable to represent a three dimensional virtual space including at least one shape may be generated. In addition, a supplemental shape may be included in the virtual space, wherein the supplemental shape was not instructed to be included in the virtual space by the software application. Further, the plurality of video frames may be displayed, wherein the supplemental shape is rendered visible.

Embodiments of the present invention may be directed to a computer system. More specifically, the computer system may include a processor, a graphics processing system coupled to the processor and including a graphics processing unit (GPU), and a communication interface operable for sending and receiving data, and memory coupled to the graphics processing system and having stored therein instructions that, if executed by the computer system, cause the computer system to execute operations. The operations may include, in response to instructions from a software application, generating a plurality of video frames that are operable to represent a three dimensional virtual space, wherein the three dimensional virtual space comprises a shape having a surface. The operations may also include applying a supplemental texture to the surface of the shape, wherein the supplemental texture is different from an original texture instructed to be applied to the surface by the software application. The operations may further include displaying the plurality of video frames, wherein the supplemental texture is rendered visible.

In various embodiments of the invention, an advertisement may be accessed and a software application that is operable to generate a plurality of video frames representing a three dimensional virtual space may be executed, wherein the three dimensional virtual space comprises a surface. While the software application is executing, a texture of the surface may be replaced with an advertisement texture representing the advertisement and using the advertisement texture, the plurality of video frames which comprise advertisement images corresponding to the advertisement texture applied to the surface may be generated. Further, the plurality of video frames including the advertisement images may be displayed.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 is a block diagram of an example of a computer system capable of implementing embodiments according to the present invention.

FIG. 2 is a block diagram of an example of a client device capable of implementing embodiments according to the present invention.

FIGS. 3A and 3B are block diagrams of systems capable of implementing embodiments according to the present invention.

FIG. 4 is a block diagram of an advertisement auction system capable of implementing embodiments according to the present invention.

FIGS. 5A and 5B depict a video frame or screen space according to an embodiment of the present invention.

FIGS. 6A and 6B depict a video frame or screen space according to an embodiment of the present invention.

FIGS. 7A and 7B depict a video frame or screen space according to an embodiment of the present invention.

FIGS. 8A and 8B depict a video frame or screen space according to an embodiment of the present invention.

FIG. 9 depicts a video frame or screen space according to an embodiment of the present invention.

FIGS. 10A and 10B depict a video frame or screen space according to an embodiment of the present invention.

FIGS. 11A and 11B depict a video frame or screen space according to an embodiment of the present invention.

FIGS. 12A and 12B depict a video frame or screen space according to an embodiment of the present invention.

FIG. 13 is a block diagram of a system including a visibility detector and advertisement engine, according to an embodiment of the present invention.

FIG. 14 depicts a flowchart of an exemplary process of determining advertisement visibility, according to an embodiment of the present invention.

FIG. 15 depicts a flowchart of an exemplary process of inserting advertisements, according to an embodiment of the present invention.

FIG. 16 depicts a flowchart of an exemplary process of inserting advertisements, according to an embodiment of the present invention.

FIG. 17 depicts a flowchart of an exemplary process of providing an advertisement auction frontend, according to an embodiment of the present invention.

FIG. 18 depicts a flowchart of an exemplary process of providing advertisements based on rules, according to an embodiment of the present invention.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

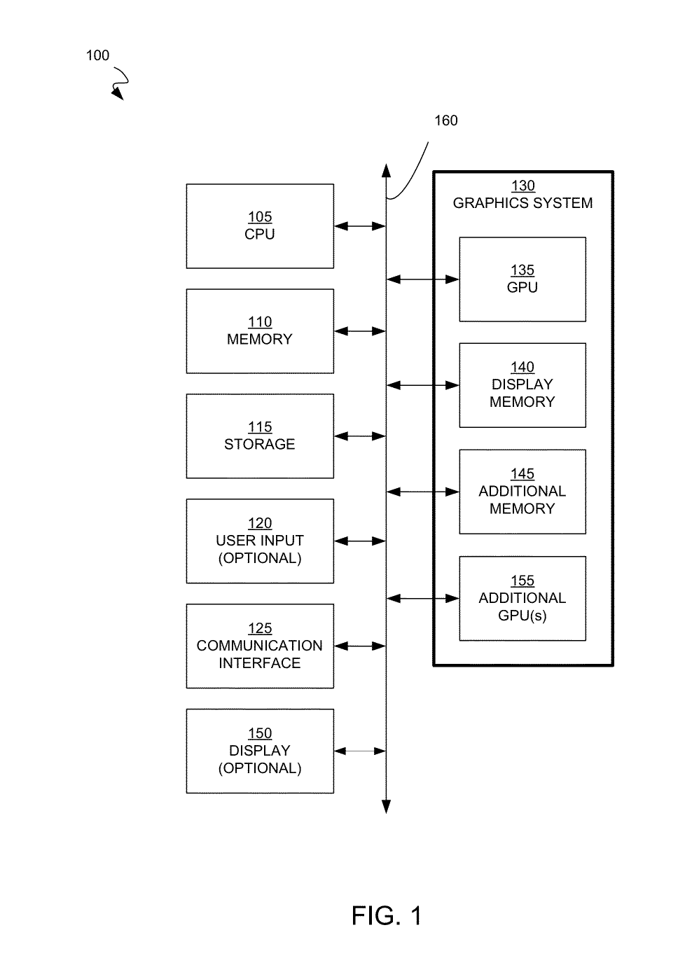

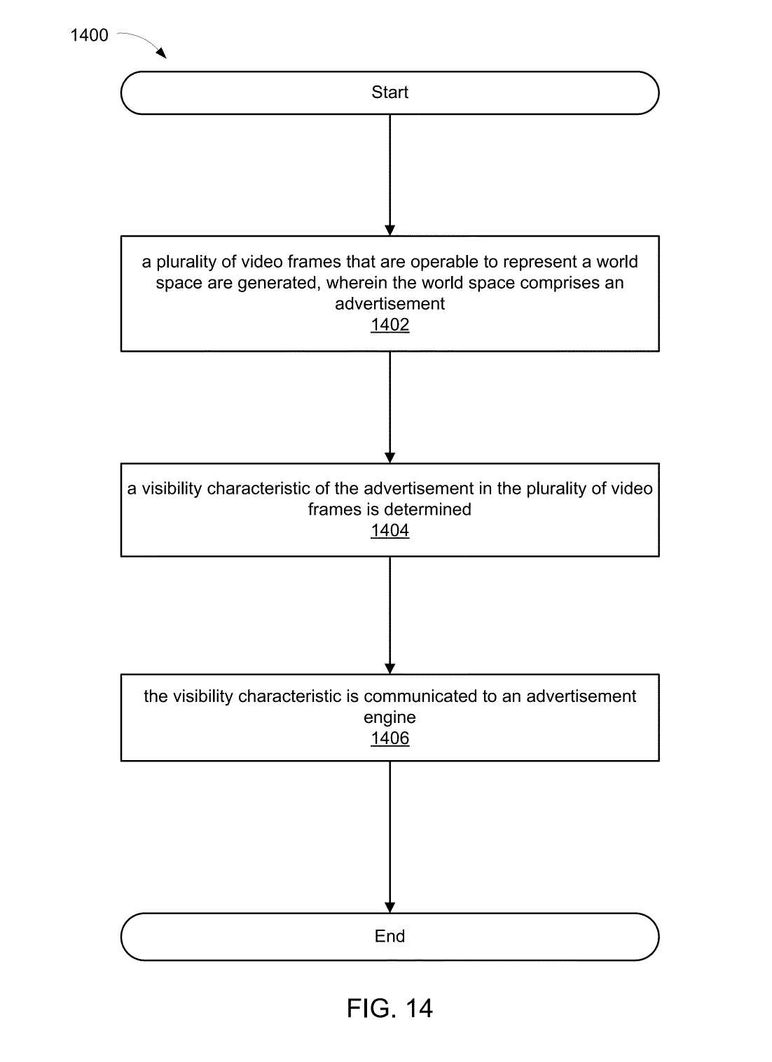

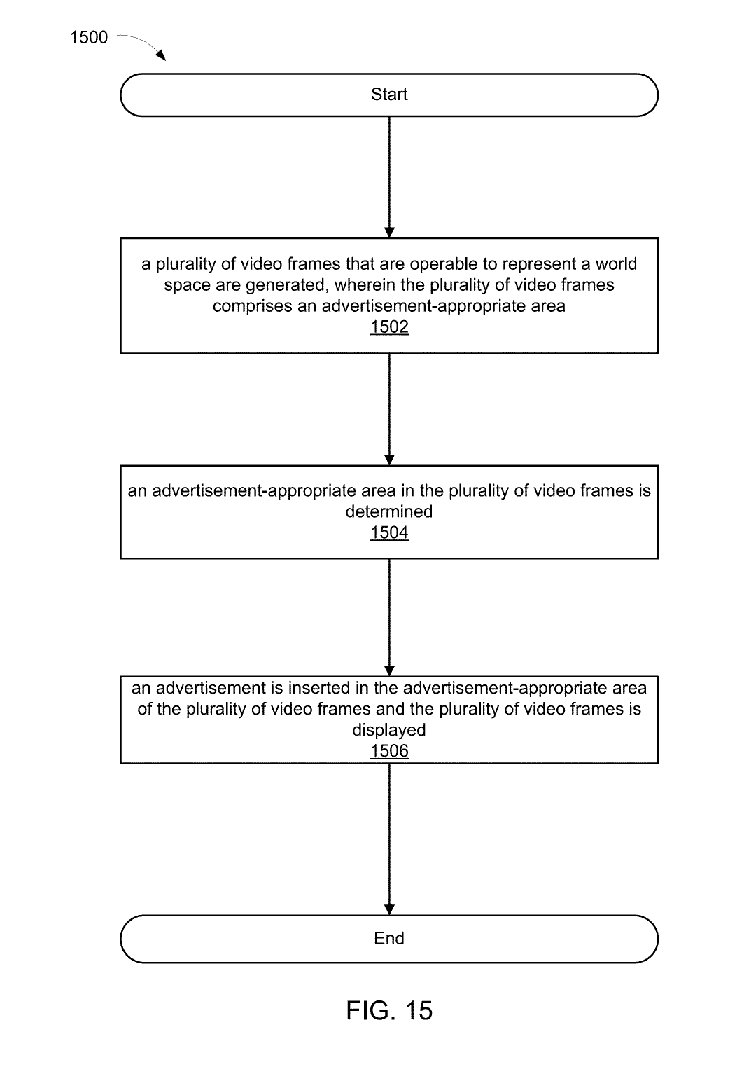

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “generating,” “sending,” “decoding,” “encoding,” “accessing,” “streaming,” or the like, refer to actions and processes (e.g., flowchart 1400 of FIG. 14 or flowchart 1500 or FIG. 15) of a computer system or similar electronic computing device or processor (e.g., system 100 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 is a block diagram of an example of a computer system 100 capable of implementing embodiments according to the present invention. In the example of FIG. 1, the computer system 100 includes a central processing unit (CPU) 105 for running software applications and optionally an operating system. Memory 110 stores applications and data for use by the CPU 105. Storage 115 provides non-volatile storage for applications and data and may include fixed disk drives, removable disk drives, flash memory devices, and CD-ROM, DVD-ROM or other optical storage devices. The optional user input 120 includes devices that communicate user inputs from one or more users to the computer system 100 and may include keyboards, mice, joysticks, touch screens, and/or microphones.

The communication or network interface 125 allows the computer system 100 to communicate with other computer systems via an electronic communications network, including wired and/or wireless communication and including the Internet. The optional display device 150 may be any device capable of displaying visual information in response to a signal from the computer system 100. The components of the computer system 100, including the CPU 105, memory 110, data storage 115, user input devices 120, communication interface 125, and the display device 150, may be coupled via one or more data buses 160.

In the embodiment of FIG. 1, a graphics system 130 may be coupled with the data bus 160 and the components of the computer system 100. The graphics system 130 may include a physical graphics processing unit (GPU) 135 and graphics memory. The GPU 135 generates pixel data for output images from rendering commands. The physical GPU 135 can be configured as multiple virtual GPUs that may be used in parallel (concurrently) by a number of applications executing in parallel.

Graphics memory may include a display memory 140 (e.g., a framebuffer) used for storing pixel data for each pixel of an output image. In another embodiment, the display memory 140 and/or additional memory 145 may be part of the memory 110 and may be shared with the CPU 105. Alternatively, the display memory 140 and/or additional memory 145 can be one or more separate memories provided for the exclusive use of the graphics system 130.

In another embodiment, graphics processing system 130 includes one or more additional physical GPUs 155, similar to the GPU 135. Each additional GPU 155 may be adapted to operate in parallel with the GPU 135. Each additional GPU 155 generates pixel data for output images from rendering commands. Each additional physical GPU 155 can be configured as multiple virtual GPUs that may be used in parallel (concurrently) by a number of applications executing in parallel. Each additional GPU 155 can operate in conjunction with the GPU 135 to simultaneously generate pixel data for different portions of an output image, or to simultaneously generate pixel data for different output images.

Each additional GPU 155 can be located on the same circuit board as the GPU 135, sharing a connection with the GPU 135 to the data bus 160, or each additional GPU 155 can be located on another circuit board separately coupled with the data bus 160. Each additional GPU 155 can also be integrated into the same module or chip package as the GPU 135. Each additional GPU 155 can have additional memory, similar to the display memory 140 and additional memory 145, or can share the memories 140 and 145 with the GPU 135.

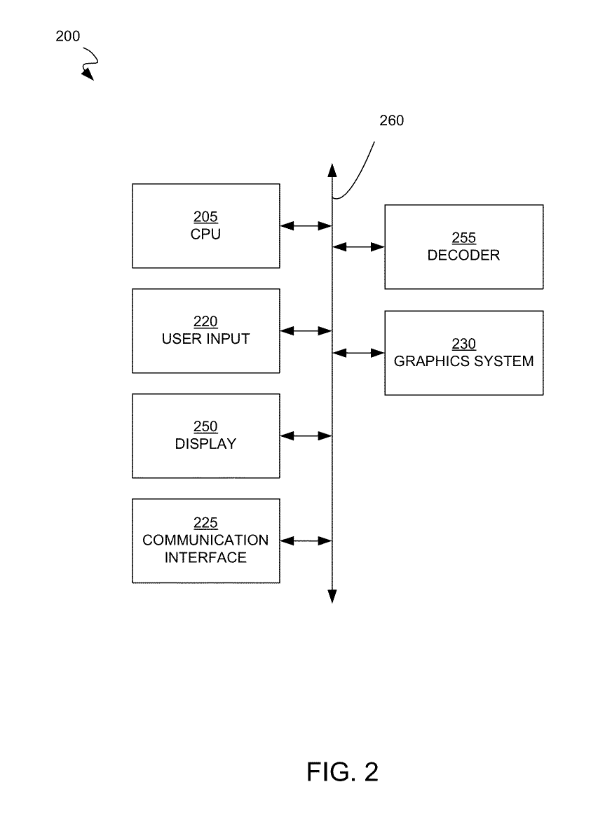

FIG. 2 is a block diagram of an example of an end user or client device 200 capable of implementing embodiments according to the present invention. In the example of FIG. 2, the client device 200 includes a CPU 205 for running software applications and optionally an operating system. The user input 220 includes devices that communicate user inputs from one or more users and may include keyboards, mice, joysticks, touch screens, and/or microphones.

The communication interface 225 allows the client device 200 to communicate with other computer systems (e.g., the computer system 100 of FIG. 1) via an electronic communications network, including wired and/or wireless communication and including the Internet. The decoder 255 may be any device capable of decoding (decompressing) data that may be encoded (compressed). For example, the decoder 255 may be an H.264 decoder. The display device 250 may be any device capable of displaying visual information, including information received from the decoder 255. The display device 250 may be used to display visual information generated at least in part by the client device 200. However, the display device 250 may be used to display visual information received from the computer system 100. The components of the client device 200 may be coupled via one or more data buses 260. Further, the components may or may not be physically included inside the housing of the client device 200. For example, the display 250 may be a monitor that the client device 200 communicates with either through cable or wirelessly.

Relative to the computer system 100, the client device 200 in the example of FIG. 2 may have fewer components and less functionality and, as such, may be referred to as a thin client. However, the client device 200 may include other components including those described above with regard to the computer system 100, for example, graphics system 230 that may be similar to graphics system 130 of FIG. 1. In general, the client device 200 may be any type of device that has display capability, the capability to decode (decompress) data, and the capability to receive inputs from a user and send such inputs to the computer system 100. However, the client device 200 may have additional capabilities beyond those just mentioned. The client device 200 may be, for example, a personal computer, a tablet computer, a television, or the like.

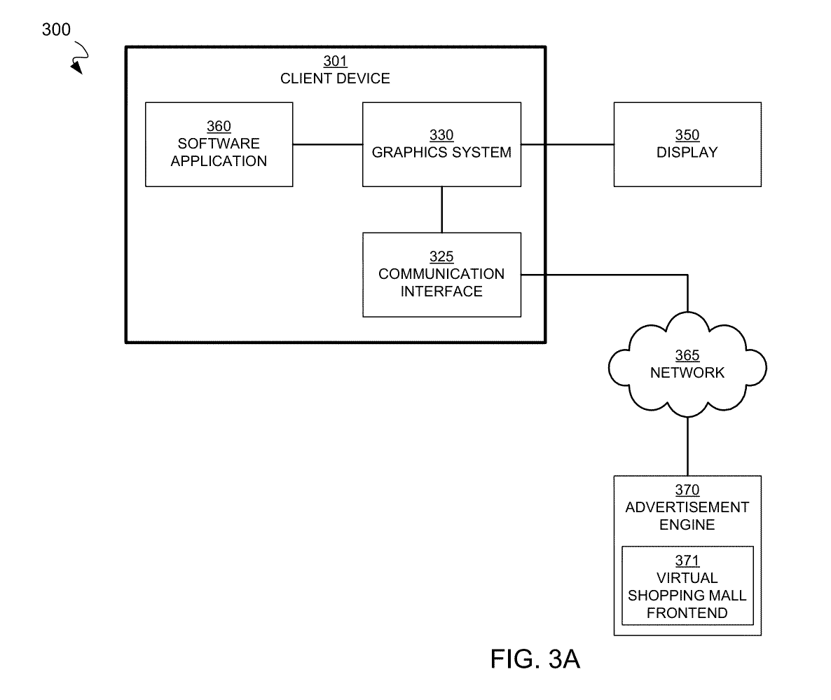

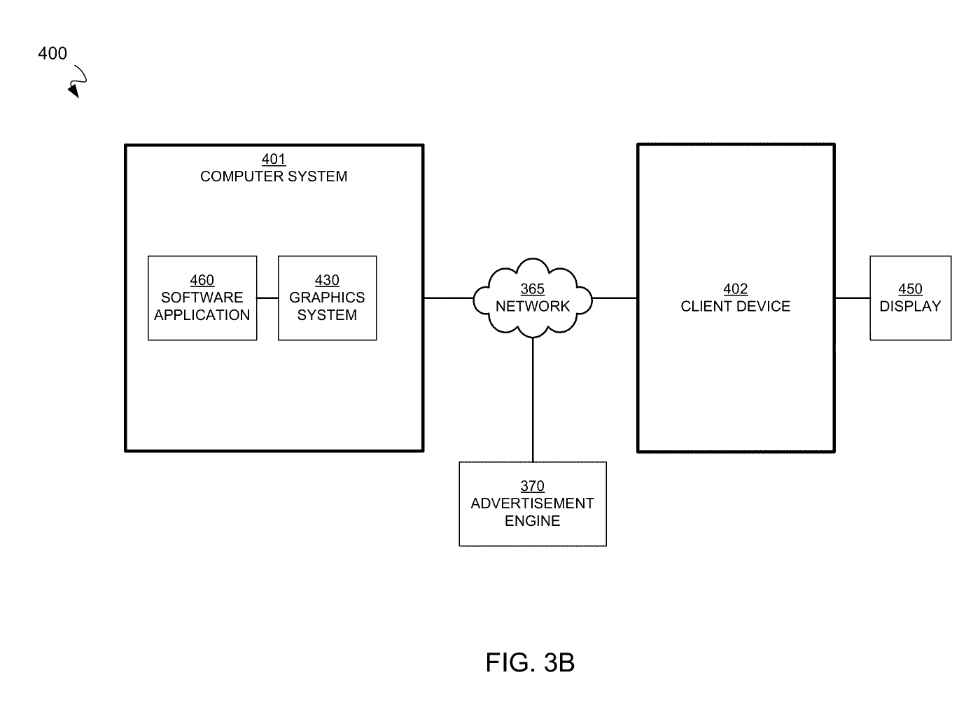

FIG. 3A is a block diagram of a system 300 capable of implementing embodiments according to the present invention. FIG. 3A includes a client device 301 that may be similar to the client device 200 of FIG. 2. For example, a graphics system 330, communication interface 325, and display 350 may be similar to the graphics system 230, communication interface 225, and display 250 of FIG. 2, respectively. Further, the client device 301 may include additional components, for example, the components included in client device 200. These components may be partially or fully coupled with one another in different configurations through, for example, a data bus.

As discussed above, client device 301 may run at least one operating system and/or software application 360. The software application 360 may be, for example, interactive media like a video game or an application operable to display video content. The software application 360 may be coupled with the graphics system 330, which in turn may be coupled with the display 350. The graphics system 330 may process data from the software application 360 in order to generate pixel data for display as images or video, on for example, the display 350. For example, the software application 360 may provide instructions, commands, and/or other data to the graphics system 330 in order for the graphics system 330 to generate an image intended for display or known by the software application 360.

Because the graphics system 330 processes and generates image data from the software application 360 before the image is displayed, the graphics system 330 may add, remove, or otherwise modify at least portions of an image that are to be displayed. Accordingly, the graphics system 330 may insert or include additional images to the images to be displayed that were not necessarily intended or known by the software application 360 when the software application 360 provided instructions to the graphics system 330.

The graphics system 330 may insert or include pixels involving a product or service advertisement into the image that is processed and generated by the graphics system 330, for example, the images in a framebuffer. Ultimately, the image with the included advertisement may be displayed for viewing by a user of the client device 301, who may be a potential customer of the advertised product or service. The graphics system 330 may cooperate with an audio system (not shown) to provide audio related to the advertisement that may be played concurrently with the display of the advertisement image.

The client device 301 may include a communication interface 325 that may be coupled with at least one network 365. The network 365 may include the Internet. An advertisement engine 370 may be coupled with the network 365. Accordingly, the graphics system 330 may be ultimately coupled with the advertisement engine 370, for example, through the communication interface 325 and the network 365. However, it should be appreciated that the advertisement engine 370 may instead be part of the client device 301.

The advertisement engine 370 may provide information related to advertisements, for example, image and/or audio data related to an advertisement. As a result, the graphics system 330 may receive advertisement information from the advertisement engine 370 and use such advertisement information to include advertisement-related images to the image generated for the software application 360. The resulting image with advertisement information may be displayed, for example, on the display 350. At the same time, audio with advertisement information, if any, may be played.

For example, the software application 360 may be interactive media like a video game that uses graphics system 330 to aid in the generation of images that are ultimately displayed on display 350. It should be understood that interactive media may include products and services on digital computer-based systems that respond to user actions by presenting content such as text, graphics, animation, video, audio, games, and so on. During the running or execution of the video game, the graphics system 330 may communicate with the advertisement engine 370 in order to receive advertisement information to include in the image of the video game. The advertisement images may be included as 2- or 3-dimensional images during 2- or 3-dimensional scenes of the video game.

In various embodiments, the advertisement engine 370 may provide advertisements based on the category, type, or genre of the software application 360 or operating system. For example, if the software application 360 is a video game involving vehicles, the advertisement engine 370 may provide advertisements for car products or auto repair services. In another example, if the software application 360 is a video game involving a sport or is video content involving a sporting match, the advertisement engine 370 may provide advertisements for sports equipment or apparel.

In addition, if the software application 360 is a video game involving different scenery or world spaces, the advertisement engine 370 may provide advertisements related to such scenery. For example, if the software application 360 is a video game involving racing vehicles, the advertisement engine 370 may provide advertisements related to beach products when the scenery includes a beach and provide advertisements related to snow-skiing equipment when the scenery includes a ski resort.

If the software application 360 involves displaying a TV show, movie, newscast, or the like, the advertisement engine 370 may provide advertisements related to such programming. For example, if the software application 360 is displaying a TV show, the advertisement engine 370 may provide advertisements related to other similar TV shows.

In some embodiments, the advertisement engine 370 may provide advertisements based on the duration that the software application 360 is run or video content is played. For example, if a video game is played for many hours, an advertisement for an energy drink or coffee may be provided since the user may be fatigued. Or, an advertisement for food like pizza may be provided since the user may have developed an appetite for food.

In one embodiment, the advertisement engine 370 may provide advertisements based on the previous advertisements that have already been provided. For example, if an advertisement related to a beverage has been recently or frequently provided in the software application 360, the advertisement engine 370 may provide an unrelated advertisement, e.g. and advertisement related to shaving cream. As a result, the advertisement engine 370 may avoid providing the same advertisement repeatedly.

In various embodiments, the advertisement engine 370 may provide advertisements based on the previous advertisements that have already been provided to other instances of the software application 360, e.g., instances of the software application 360 that have run or that are running on other client devices 301 used by the same user. For example, if an advertisement related to a beverage has been recently or frequently provided in a first software application of a first client device, the advertisement engine 370 may provide an unrelated advertisement to a second software application of a second client device owned by the user, e.g., an advertisement related to shaving cream.

In embodiments of the invention, the advertisement engine 370 may provide location-based advertisements, e.g., the advertisement engine 370 may provide advertisements based on the location of the client device 301 or the display 350. For example, if a user is playing a video game on a tablet device or laptop near a coffee shop, the advertisement engine 370 may provide advertisements related to the coffee shop.

If the advertisement engine 370 has access to information related to a user's visitation history of past locations, the advertisement engine 370 may provide advertisements based on such information. For example, if the user has frequently and/or recently visited a certain coffee shop, the advertisement engine 370 may provide advertisements related to the coffee shop. The user's visitation history information may be based on various factors including but not limited to visitations recorded by the current device or other devices in the past, credit card transaction history, a user profile indicating preferences, search history, comments on social networking websites, comments made in email messages, and/or advertisements the user has interacted with (discussed below).

In various embodiments, the advertisement engine 370 may provide advertisements based on the device being used by the user. For example, if the client device 301 is a mobile phone, the advertisement engine 370 may provide advertisements related to products that are compatible with the model of the mobile phone like chargers, external speakers, phone cases, and so on. If the client device 301 is a cable to satellite TV set-top box, the advertisement engine 370 may provide advertisements related to television programming like TV shows or sportscasts. If the client device 301 is a home gaming console, the advertisement engine 370 may provide advertisements relevant to home owners like advertisements for home goods, loan refinancing, or food delivery options like pizza delivery.

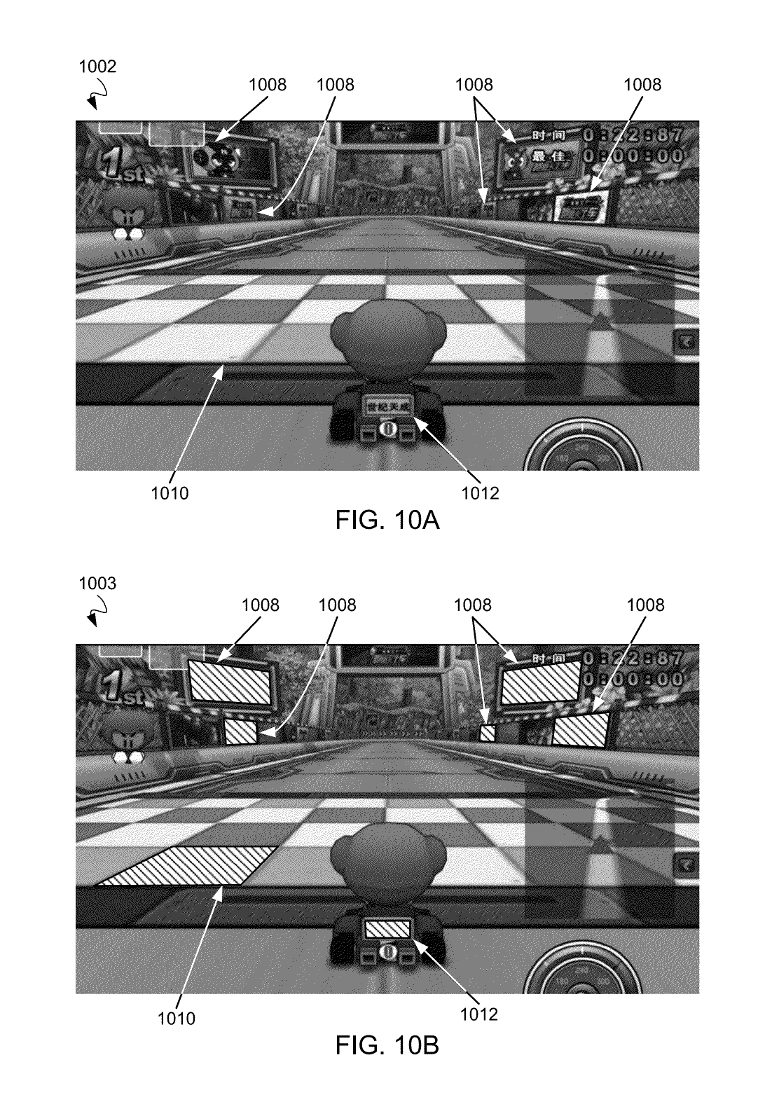

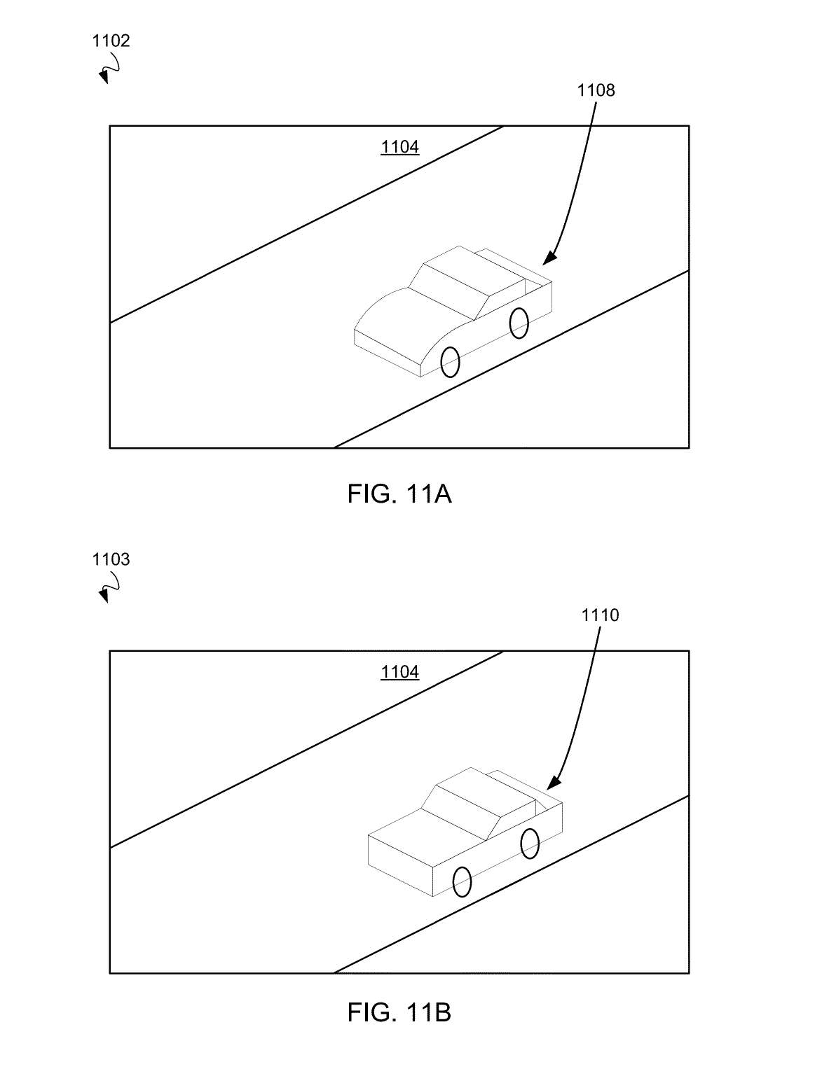

As discussed with respect to FIGS. 10A, 10B, 11A, and 11B below, images or textures may be inserted by a graphics system into video frames such that objects or shapes are overlaid with the images or textures. Further, entire 3D objects or shapes may be added, removed, or modified by a graphics system.

The advertisement engine 370 may also include a virtual shopping mall frontend 371. The virtual shopping mall frontend 371 may be communicatively coupled with the graphics system 330 through the advertisement engine 370 and/or network 365. It should be appreciated that the virtual shopping mall frontend 371 may not necessarily be within the advertisement engine 370, but may be a standalone component or within another separate component.

The virtual shopping mall frontend 371 may be operable to provide images, textures, skins, or virtual objects to users for inclusion into the software application 360 when such items were not necessarily intended or known by the software application 360 when the software application 360 provided instructions to the graphics system 330. For example, a user may select, through the virtual shopping mall frontend 371, a texture to be overlaid on a character's outfit. In another example, a user may select an exhaust pipe or rims to customize a virtual car. The virtual shopping mall frontend 371 may offer such items for a fee.

FIG. 3B is a block diagram of a system 400 capable of implementing embodiments according to the present invention. FIG. 3B may include a computer system 401 that is similar to the computer system 100 of FIG. 1. For example, a graphics system 430 may be similar to the graphics system 130 of FIG. 1. Further, the computer system 401 may include additional components, for example, the components included in computer system 100. These components may be partially or fully coupled with one another in different configurations through, for example, a data bus. FIG. 3B also includes a client device 402 that may be similar to the client device 200 of FIG. 2. The computer system 401 and client device 402 may be coupled with the network 365 and the advertisement engine 370.

The computer system 401 may run at least one operating system and/or software application 460. The software application 460 may be, for example, a video game or an application operable to display video content. The software application 460 may be coupled with the graphics system 430. The graphics system 430 may process data from the software application 460 in order to generate pixel data for display as images or video, on for example, the display 450 as discussed below. For example, the software application 460 may provide instructions, commands, and/or other data to the graphics system 430 in order for the graphics system 430 to generate an image intended by the software application 460.

The computer system 401 may communicate the image to be displayed to the client device 402. For example, the image to be displayed may be communicated from the computer system 401, through the network 365, and to the client device 402. The images or video that is communicated may or may not be compressed before sending by the computer system 401, and decompressed and/or decoded when received by the client device 402. For example, the computer system 401 may compress the graphics data into H.264 format for transmittal to the client device 402. Once the client device 402 receives the image or video to be displayed, it may display the image or video on the display 450.

Because the graphics system 430 processes and generates image data from the software application 460 before the image is displayed, the graphics system 430 may add, remove, or otherwise modify at least portions of an image that are to be displayed. Accordingly, the graphics system 430 may include additional images to the images to be displayed that were not intended for display or known by the software application 460 when the software application 460 provided instructions to the graphics system 430.

The graphics system 430 may insert or include pixels involving a products or services advertisement into the image that is processed and generated by the graphics system 430. Ultimately, the image with the included advertisement may be displayed for viewing by a user of the client device 402, who may be a potential customer of the advertised product or service. The graphics system 430 may cooperate with an audio system (not shown) to provide audio related to the advertisement that may be played concurrently with the display of the advertisement image.

As discussed above, the advertisement engine 370 may provide information related to advertisements, for example, image and/or audio data related to an advertisement. As a result, the graphics system 430 may receive advertisement information from the advertisement engine 370 and use such advertisement information to insert or include advertisement-related images to the image generated for the software application 460. The resulting image with advertisement information may be displayed, for example, on the display 450. At the same time, audio with advertisement information, if any, may be played.

For example, the software application 460 may be a video game that uses graphics system 430 to aid in the generation of images that are ultimately displayed on display 450. During the running or execution of the video game, the graphics system 430 may communicate with the advertisement engine 370 in order to receive advertisement information to include in the image of the video game. The advertisement images may be included as 2- or 3-dimensional images during 2- or 3-dimensional scenes of the video game.

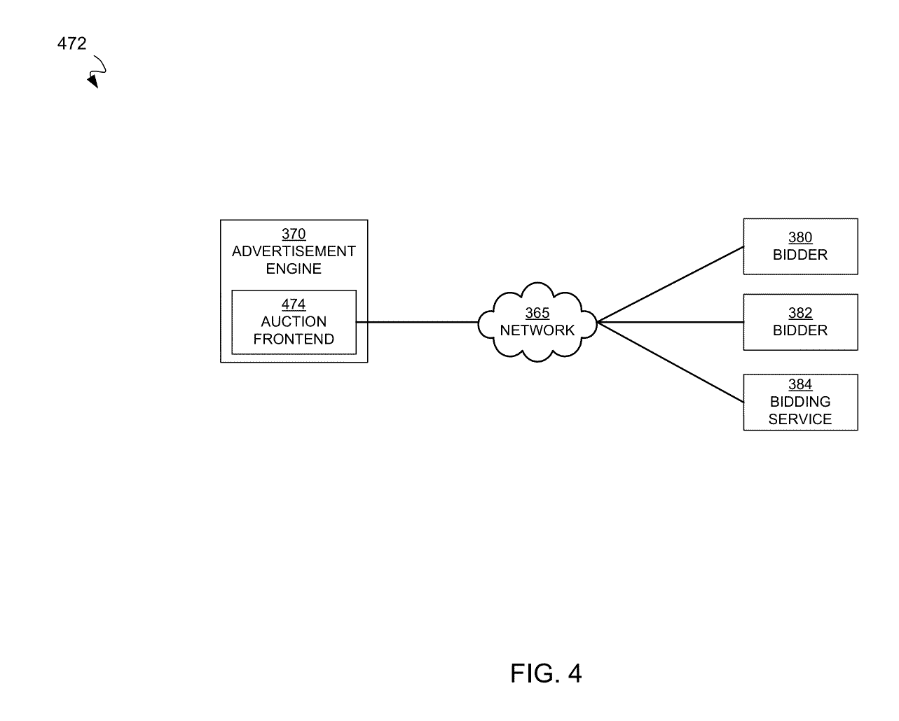

FIG. 4 is a block diagram of an advertisement auction system 472 capable of implementing embodiments according to the present invention. FIG. 4 includes the advertisement engine 370 and the network 365 of FIGS. 3A and 3B. The advertisement engine 370 may include an auction frontend 474 that may be communicatively coupled with the network 365.

The auction frontend 474 may be operable to accept advertisement bids from various bidders, for example, a bidder 380, a bidder 382, and/or a bidding service 384. The bidders 380 and 382 may be advertisers of their own products, while the bidding service 384 may be a brokerage company that performs bidding services for advertisers. The various bidders may be communicatively coupled with the auction frontend 474 through the network 365 and/or the advertisement engine 370. It should be appreciated that the auction frontend 474 may not necessarily be within the advertisement engine 370, but may be a standalone component or within another separate component.

The advertisement engine 370 may provide advertisements to the graphics systems 330 or 430 of FIGS. 3A and 3B based on advertisement bids placed by the bidders through the auction frontend 474. The auction fronted 474 may provide automatic bidding, where bidders may specify maximum bid amounts and the auction frontend 474 may automatically adjust the actual amount charged within a range such that the actual amount charged is lower than the maximum bid and higher than competing bids. Alternatively, the auction frontend 474 may provide manual bidding, where bidders may manually specify a bid amount that is constant.

The advertisement engine 370 may provide advertisements to the graphics systems based on the bid amount, the relevancy of the advertisement, and/or both factors. For example, if a first bidder places a bid for the inclusion of an advertisement that is higher than all other bidders, that advertiser's advertisement may be chosen by the auction frontend 474 for advertising.

The relevancy of the advertisement may be based on the duration of viewing of the advertisement, which may indicate that the advertisement is relevant to certain placements. For example, in a volleyball video game, an advertisement for volleyball products may be viewed longer than an advertisement for fast food because players of such a game may be more interested in volleyball products than fast food. As a result, the volleyball product advertisement is more relevantly placed and will be displayed more often than the fast food advertisement in the volleyball video game. The relevancy of the advertisement may be based on other factors, for example, how often advertisements are interacted with, whether the advertisement is relevant to a game type, whether the advertisement fits the scenery or the object advertised on, and so on.

In some embodiments, bidders may place bids on specific advertisement areas. For example, a bidder may choose to advertise on a specific billboard in a specific racetrack of a specific game. Alternatively, bidders may place bids on groups of advertisements. For example, a group of advertisements may include bundled advertisement placements in related areas of a virtual game, e.g. advertisements only on virtual character t-shirts.

In various embodiments, bidders may also limit their bids such that resulting advertisements are only placed in certain categories. For example, a bidder may indicate that their advertisements should be limited to only a specific game, game category (sports games, first person shooter games, etc), content types (video games only, TV shows only, etc), and so on. Bidders may place bids on advertisements that are animated or interactive. Such advertisements may be more expensive because of their active nature.

In embodiments of the invention, bidders may place bids based on factors discussed with relation to FIG. 3A. For example, a bidder may place bids on advertisements that will be provided after a predetermined duration of game play, advertisements that are based on a user profile, advertisements based on the device used to execute or view the software application, and so on.

In further embodiments, bidders may bid based demographics or geographic location. For example, a first bidder may place bids for advertisement space on the side of a bus in a virtual world played by a gamer in the US, while a second bidder may place bids for advertisement space on the side of the same played by a gamer in the Italy. In fact, it should be appreciated that during a multiplayer session of the game, if gamers in the US and Italy are concurrently viewing the advertisement, a different advertisement may be shown to each player.

In some embodiments, the advertisement engine 370 may provide advertisements based on ongoing agreements with advertisers. For example, the advertisement engine 370 may provide advertisements for a certain product or service more or less frequently based on the amount an advertiser has agreed to pay for such advertisements. In another example, the advertisement engine 370 may provide advertisements for a certain product or service for a period of time sought by an advertiser, but later removed or changed to a different advertisement based on the advertiser's preference. Such changes may occur real-time since the advertisement engine 370 may provide different advertisements at any time.

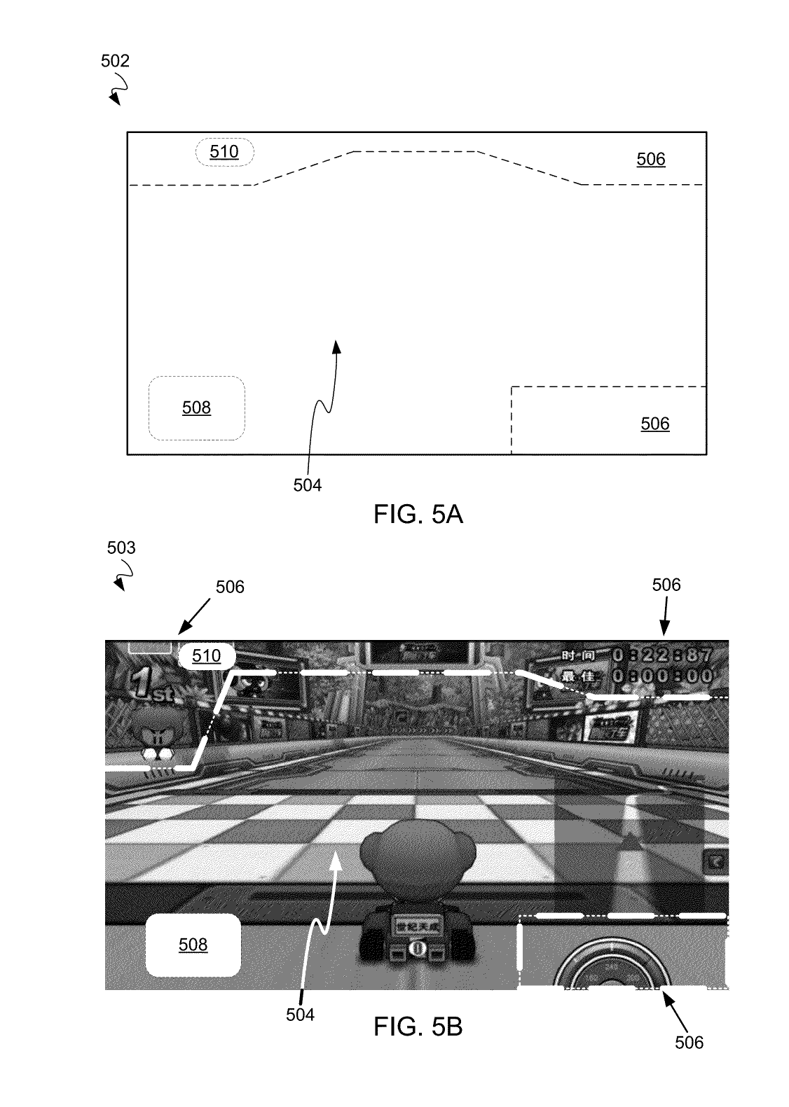

FIGS. 5A and 5B depict a video frame or screen space 502 and 503 according to an embodiment of the present invention. In FIG. 5A, the video frame 502 illustrates a frame of a video game or video content that may be displayed on a client device display.

A content area 504 may be used to display the content of a software application, for example the world space or play area for a video game, a scene in a movie or television show, a televised sporting event, or other media. World space refers to the virtual world of a video game that is provided to a player. For example, the world space may be a race track or a city that the character of a player can travel around in. World spaces are often referred to as a level or a map. Screen space refers to a portion of the world space that is presented on a display for viewing by a user. The portion may include the entire world space or a subset of the world space. For example, the screen space may present only the point of view of a character “looking” down a city street, while other portions of the city are not presented on the screen space. It should be appreciated that world space could also refer to the world inside of a TV show, film, sports cast, newsroom, and so on.

There may be one or more statistics areas 506 that may overly or share the content area 504. The statistics areas 506 may include for example statistics related to video game play or statistics related to a sporting event.

The video frame 502 may also include at least one advertisement area 508 or 510. The advertisement area 508 may overly the content area 504 or the advertisement area 510 may be included within the statistics area 506. The advertisement area 508 or 510 may include an advertisement image or video that is inserted by a graphics system that has processed and/or generated the video frame 502. For example, as discussed with relation to FIGS. 2 and 3, advertisement data may be provided to the graphics system by an advertisement engine 370 and displayed in the advertisement area 508 or 510.

If the content area 504 may be used to display a sporting event, and the statistics areas 506 may be used to display a game statistics, e.g. the statistics areas 506 may include a scoreboard overlay. Advertisement areas may be included within or adjacent to such a scoreboard overlay.

In one embodiment, the graphics system may determine what areas in video frame 520 are preferably advertisement areas if the software application developer or video content provider indicates which areas are appropriate or suitable for advertisements. Such a developer or provider may benefit from an agreement with a commercial brokerage entity that arranges the advertisements, the advertisers (the entity offering the advertised goods or services), and/or the entity that developed or maintains the advertising engine 370 and/or graphics system 330 or 430 capable of inserting advertisements. For example, a developer may benefit from a profit-sharing agreement related to the profits derived from the charges to advertise or the profits resulting from product/service revenues. Accordingly, the graphics system may include advertisements in the appropriate areas.

In various embodiments, the appropriate advertisement areas may be determined by first executing a software application to determine appropriate areas of the video frame 520, store those areas, and provide information regarding the determined appropriate areas to the graphics system for the inclusion of advertisements. For example, in a video game, an appropriate advertisement area may be first determined by “playing” the game once while identifying and recording advertisement areas. The location of such areas may be stored in a graphics system driver so that when the game is played later, the graphics system may display advertisements in the areas recorded as being appropriate.

In some embodiments, the graphics system may analyze the video frame 520 real-time and insert advertisements in areas that the graphics system determines to be appropriate. Accordingly, the graphics system may include advertisements in the appropriate areas. For example, if a video game includes new and randomly generated sceneries or world spaces, a graphics system may determine real-time or on-the-fly areas that are appropriate for advertisements.

It should be appreciated that inserted images are not limited to advertisements. Embodiments of the invention include inserting any image for any purpose. For example, an inserted image may be used to notify a user about breaking news, provide gaming tips, etc.

FIG. 5B illustrates an example video frame 503 for a video game. The video frame 503 includes content area 504 which displays the game scenery, for example, a race track and the player's character. Statistics areas 506 indicate or display statistics related to game play. For example, statistics areas 506 indicate the player's rank, the elapsed time, and the speed of the player's character. Advertisement areas 508 and 510 may be included in the video frame 503.

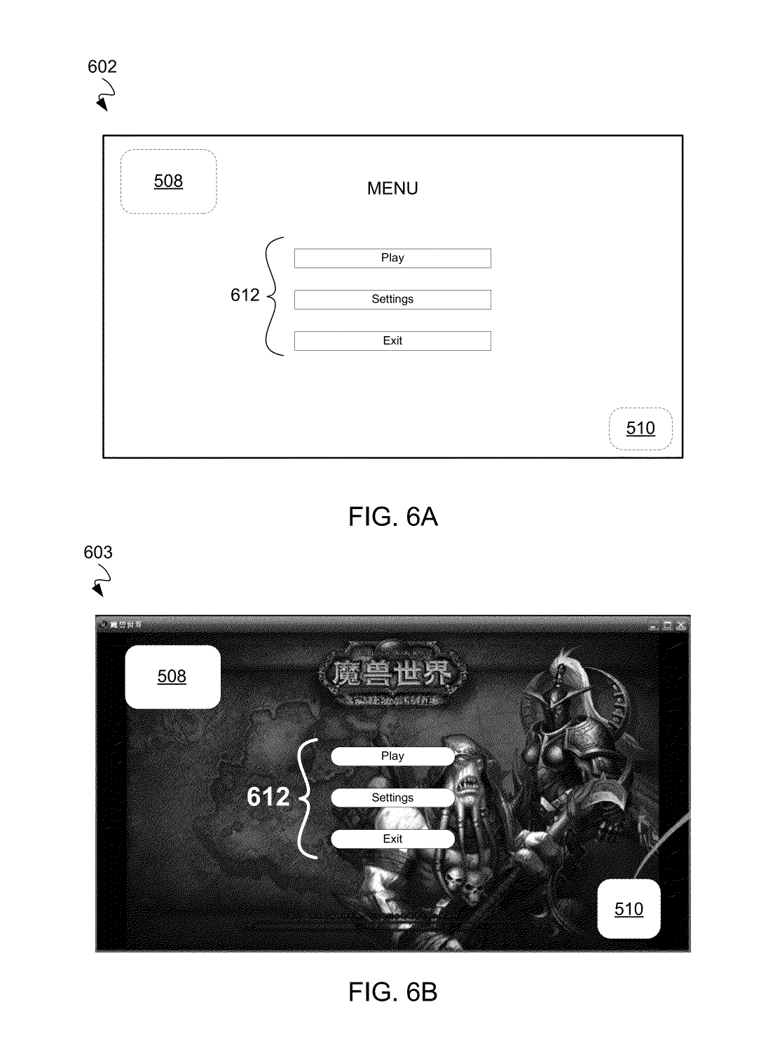

FIGS. 6A and 6B depict a video frame or screen space 602 and 603 according to an embodiment of the present invention. During different modes of a video game, advertisements may be displayed. For example, an advertisement may be displayed while a video game displays a menu. In FIG. 6A, the video frame 602 includes a menu 612. A graphics system may include an advertisement area, for example such as advertisement area 508, in an appropriate area on the menu screen. As discussed with relation to FIGS. 2 and 3, advertisement data may be provided to the graphics system by an advertisement engine 370 and displayed in the advertisement area 508 or 510. It should be appreciated that there may be one or multiple advertisements and that such advertisements may be positioned on different areas of the video frame. For example, advertisement area 510 may be included alone or concurrently with advertisement area 508.

FIG. 6B depicts a video frame 603 showing a menu screen of a video game. For example, the video frame 603 includes a menu 612. In addition, the video frame 603 includes advertisement areas 508 and 510.

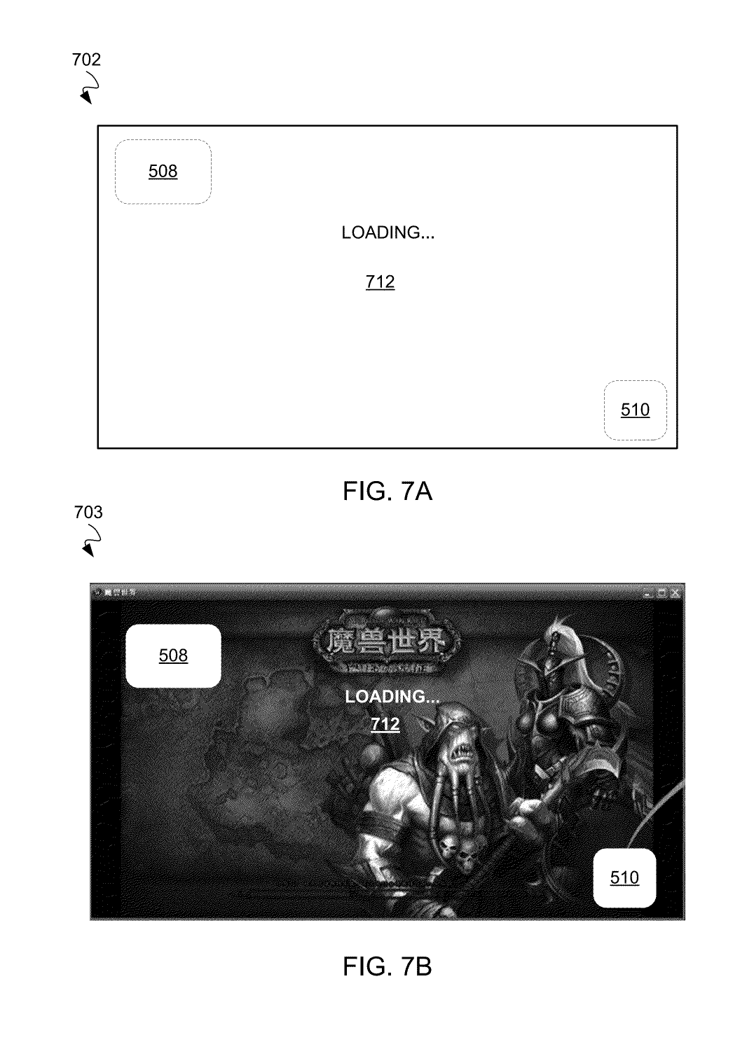

FIGS. 7A and 7B depict a video frame or screen space 702 and 703 according to an embodiment of the present invention. An advertisement may be displayed while a video game is in a loading state. In FIG. 7A, the video frame 702 includes a loading page 712. A graphics system may include an advertisement area, for example such as advertisement area 508, somewhere on the loading page while the user waits for the loading step to complete. As discussed with relation to FIGS. 2 and 3, advertisement data may be provided to the graphics system by an advertisement engine 370 and displayed in the advertisement area 508 or 510. It should be appreciated that there may be one or multiple advertisements and that such advertisements may be positioned on different areas of the video frame. For example, advertisement area 510 may be included alone or concurrently with advertisement area 508.

FIG. 7B depicts a video frame 703 showing a loading page of a video game. For example, the video frame 703 includes a loading page 712. In addition, the video frame 703 includes advertisement areas 508 and 510.

A graphics system may apply the same processes to other types of media other than video games, for example, video content like television shows, movies, or sporting events. The graphics system may determine appropriate advertisement areas similarly to the process that may be used for video games. For example, content providers may indicate what areas are appropriate for advertising. Alternatively, the video could be played once and the appropriate advertisement areas could be identified and stored. Otherwise, the graphics system may identify appropriate advertisement areas real-time.

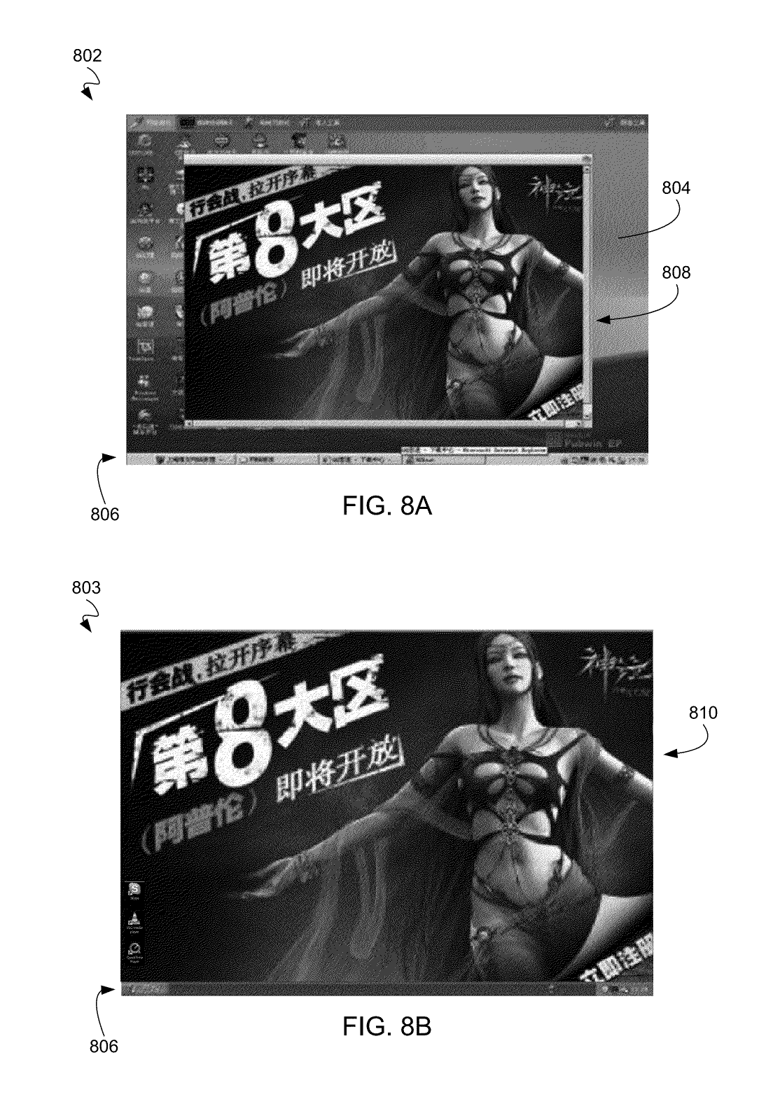

FIG. 8A depicts a video frame or screen space 802 according to an embodiment of the present invention. The video frame 802 illustrates a frame of an operating system that may be displayed on a client device display. A content area 804 may include a desktop background and file icons. A menu bar 806 may be displayed to provide controls for the operating system. An advertisement window 808 may be displayed in at least part of the video frame 802, for example, overlying the content area 804. As discussed with relation to FIGS. 2 and 3, advertisement data may be provided to the graphics system by an advertisement engine 370 and displayed in the advertisement window 808.

FIG. 8B depicts a video frame or screen space 803 according to an embodiment of the present invention. A video frame 803 illustrates a frame of an operating system that may be displayed on a client device display. The video frame 803 may include a desktop background 810 and file icons. A menu bar 806 may be displayed to provide controls for the operating system. The desktop background 810 may display an advertisement image, for example, behind any file icons, adjacent to any menu bar, and/or behind an at least partially translucent menu bar. As discussed with relation to FIGS. 2 and 3, advertisement data may be provided to the graphics system by an advertisement engine 370 and displayed by the desktop background 810.

It should be appreciated that a graphics system may include advertisement images or content as part of any frame of an operating system to be rendered on a display. For example, while advertisement content may be included in an advertisement window or advertisement desktop background, advertisement images could also be included as part of a login screen of the operating system. Moreover, advertisement images could be included inside the 2-dimensional window of an application. In addition, audio corresponding to the advertisement content may also be played.

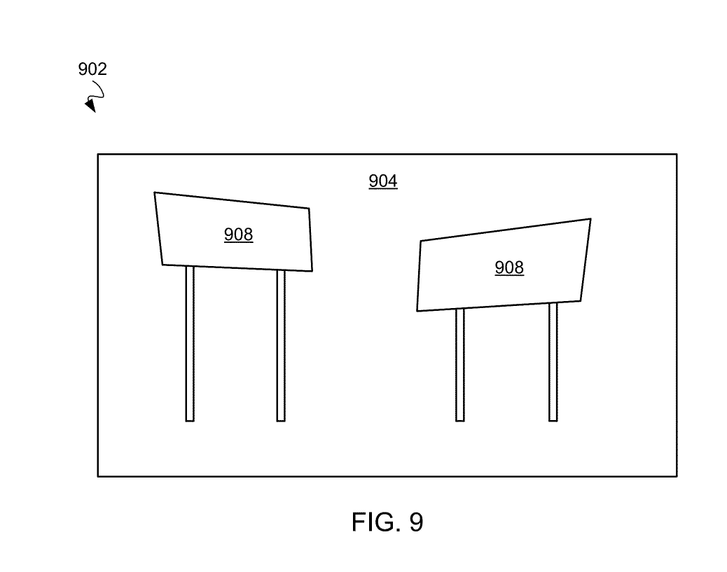

FIG. 9 depicts a video frame or screen space 902 according to an embodiment of the present invention. Video frame 902 may depict a graphical 3-dimensional scene or world space 904 generated by a graphics system in cooperation with a software application, for example, a video game. The world space 904 may include various 3-dimensional objects. For example, the world space 904 may include objects that appear as billboards 908. The software application may intend to depict certain images on the surface of the objects, for example, predetermined advertisements on the surface of the billboards 908. The graphics system may do so by applying a texture map that corresponds to the images to the surface of the objects.

As discussed with respect to FIGS. 3A and 3B, because the graphics system may process and generate image data from the software application before the image is displayed, the graphics system may add, remove, or otherwise modify at least portions of an image that are to be displayed. Accordingly, the graphics system may apply images to the objects in the world space 904 that were not intended or known by the software application when the software application provided instructions to the graphics system. As discussed with relation to FIGS. 2 and 3, the applied images may include advertisements that were provided to the graphics system by an advertisement engine 370.

For example in a video game, the graphics system may use a texture map not specified by the software application to draw a texture on the objects. In FIG. 9, a graphics system may apply a texture map to billboards 908 that was not intended nor known by the software application. The texture map may include advertisement data and further the advertisement data may have been provided by an advertisement engine.

In one embodiment, the graphics system may determine what objects in video frame 902 are appropriate for displaying advertisements if the software application developer or video content provider indicates which objects are appropriate for advertisements. Accordingly, the graphics system may apply texture maps to the appropriate objects.

In various embodiments, the appropriate advertisement areas may be determined by first executing a software application to determine appropriate objects of the world space 904, store those objects, and provide information regarding the determined appropriate objects to the graphics system for inclusion of advertisements. For example, in a video game, an appropriate advertisement object may be first determined by “playing” the game once while identifying and recording objects that are appropriate for advertisements. The location of such objects may be stored in a graphics system driver so that when the game is played later, the graphics system may display advertisements on the objects recorded as being appropriate. Accordingly, the graphics system may apply texture maps to the appropriate objects.

In some embodiments, the graphics system may analyze the world space 904 real-time and insert advertisements onto objects that the graphics system determines to be appropriate. Accordingly, the graphics system may apply texture maps to the appropriate objects. For example, if a video game includes new and randomly generated sceneries or world spaces, a graphics system may determine real-time or on-the-fly areas that are appropriate for advertisements

FIGS. 10A and 10B depict a video frame or screen space 1002 and 1003 according to an embodiment of the present invention. The video frame 1002 in FIG. 10A depicts a frame from a video game that displays a 3-dimensional scene or world space. The scene includes 3-dimensional objects intended or known by a software application, such as various billboards 1008 that are presented with different sizes, angles, distances, and images. The scene also includes other objects like a floor with a tile pattern 1010. Further, the scene includes a game character on a vehicle with various objects like a vehicle license plate 1012.

FIG. 10B depicts a video frame or screen space 1003 according to an embodiment of the present invention. As discussed above, a graphics system may determine what objects in video frame 1002 are appropriate for displaying advertisements. The video frame 1003 of FIG. 10B illustrates areas that the graphics system may identify as areas appropriate for advertisements. For example, the billboards 1008, a tile of the tile pattern 1010, and the license plate 1012 of the character may be identified as advertisement areas. Accordingly, advertisements that were not necessarily intended or known by the software application may be included in these areas by the graphics system. The advertisements may be applied as texture maps to surfaces so that the advertisement images will have an appropriate perspective to a viewer of the video frame 1003.

It should be appreciated that appropriate advertisement surfaces are not limited to billboards, floors, or license plates, but may include any object, for example the side or interior of a bus, buildings, racecars, character jerseys, hats, other apparel generally, subway tunnels, cereal boxes, and so on. Further, it should be borne in mind that appropriate advertisement surfaces are not limited to flat surfaces, but may be included on 3-dimensional objects, for example, uneven or curved surfaces. For example, an advertisement image may be overlaid on a cylindrical soda can or a typically shaped ketchup bottle.

A graphics system may apply the same processes to other types of media other than video games, for example, video content like television shows, movies, or sporting events. The graphics system may determine appropriate advertisement areas similarly to the process that may be used for video games. In various embodiments, content providers may indicate what areas are appropriate for advertising. In another embodiment, the video content could be played back once and the appropriate advertisement areas could be identified and stored. In some embodiments, the graphics system may identify appropriate advertisement areas real-time or “on-the-fly.” The graphics system may include advertisements in the appropriate areas corresponding to advertisement data provided by an advertisement engine. For example, a billboard in a television show, a drink can in a movie, or side paneling of a field in a sporting event may be determined as appropriate advertisement areas and overlaid with an advertisement.

It should be appreciated that while embodiments of the invention have been discussed with a single frame, inserted images or textures may span multiple frames. For example, an advertisement in advertisement area 508 of FIGS. 5A and 5B may be present throughout multiple frames while the content area 504 changes. Similarly, advertisements in the advertisement world space 904 areas 1008, 1010, and 1012 of FIGS. 10A and 10B may be present throughout multiple frames while the video frame 1002 changes.

In some embodiments, the inserted images or textures may change from one video frame to another. For example, the designated area may include one advertisement for one or more frames, then change to second advertisement during one or more frames. The change may occur while the designated area is still being displayed in the frame. In addition, before the second advertisement is included, the first advertisement may disappear for one or more frames. When the advertisement is a texture on a 3-dimensional object, the advertisement may change after the advertisement surface is no longer in the video frame or the screen space of a display. For example, in FIGS. 10A and 10B, the advertisements in the areas 1008 and 1010 may be changed when the player's character revisits that scene on a subsequent racing lap.

In various embodiments, while the advertisement image may change between frames, the images may still relate to a single advertisement. In other words, the advertisement be animated or displayed as a video. For example, the advertisement area 508 of FIGS. 5A and 5B may be animated. In another example, advertisement area 1008 may be animated. For example, a virtual world may be set in New York's Times Square, where animated billboards may be simulated in the virtual world.

In some embodiments, the advertisement may be interactive. For example, an interactive process may begin if a user clicks on the advertisement areas 508 in FIGS. 5A and 5B or taps on an area of the screen of a display corresponding to the advertisement areas 508 in the case of a touchscreen device. An interactive process may begin if a user clicks or taps the advertisement areas 1008, 1010, or 1012 in FIGS. 10A and 10B, or if the user interacts with the advertisement during gameplay. For example, if the user's character drives over the tile 1010 or launches a projectile at the billboards 1008, an interactive process may begin.

The interactive process may include but is not limited to beginning an animation of the advertisement, playing audio related to the advertisement, beginning a nested or sub game, sending a message to the user outside of the game (e.g., an email to the user's email account), and/or opening a webpage in an Internet browser.

FIGS. 11A and 11B depict a video frame or screen space 1102 and 1103 according to an embodiment of the present invention. As discussed with respect to FIGS. 3A and 3B, the graphics system may process and generate image data from the software application before the image is displayed, and so the graphics system may add, remove, or otherwise modify at least portions of an image that are to be displayed. In addition, the graphics system may add, remove, or otherwise modify 3-dimensional objects. Accordingly, the graphics system may add, remove, or modify objects in a world space that were not intended or known by the software application when the software application provided instructions to the graphics system. The additions, removals, or modifications of objects may be related to advertisements that were provided to the graphics system by an advertisement engine 370.

FIG. 11A includes a content area or world space 1104 that may depict a graphical 3-dimensional scene generated by a graphics system in cooperation with a software application. For example, the world space 1104 includes a 3-dimensional object representing a car 1108. The software application may intend to depict the objects as certain objects, for example, a car with a certain make and model. The graphics system may do so by generating the 3-dimensional object in the world space 1104.

However, the graphics system may add, remove, or modify such objects. For example, FIG. 11B includes the same content area or world space 1104 of FIG. 11A but with a car 1110 with a different make and model as the car 1108 of FIG. 11A. The advertisement engine 370 may provide information related to which make and model of a car to change the car to. The advertisement engine 370 may provide such information based on, for example, similar types of analysis as discussed with relation to FIG. 3A. In addition, the graphics system may entirely remove the car 1108, add additional cars to the world space 1104, or both.

Accordingly, different products may be advertised. It should be appreciated that inserted objects are not limited to advertisements. Embodiments of the invention include inserting any object for any purpose. For example, an inserted object may be inserted based on user preferences or purchases of objects.

In various embodiments, a graphics system and/or an audio system may add, remove, or modify audio associated with media ultimately played for a user. For example, in a video game, if a character offers a beverage of a certain brand by saying “here's a brand1 soda,” the “brand1” portion of the audio may be replace with “brand2,” where “brand1” and “brand2” are the names of soda beverages.

The principles discussed above relating to visual advertisements may apply to audio advertisements as well. For example, the appropriate audio to be replaced may be determined by cooperation with the developer of the media containing the audio, by analyzing the audio after playing the media at least once, or by real-time analysis. Or, for example, an advertisement engine may provide the audio that will replace the original audio.

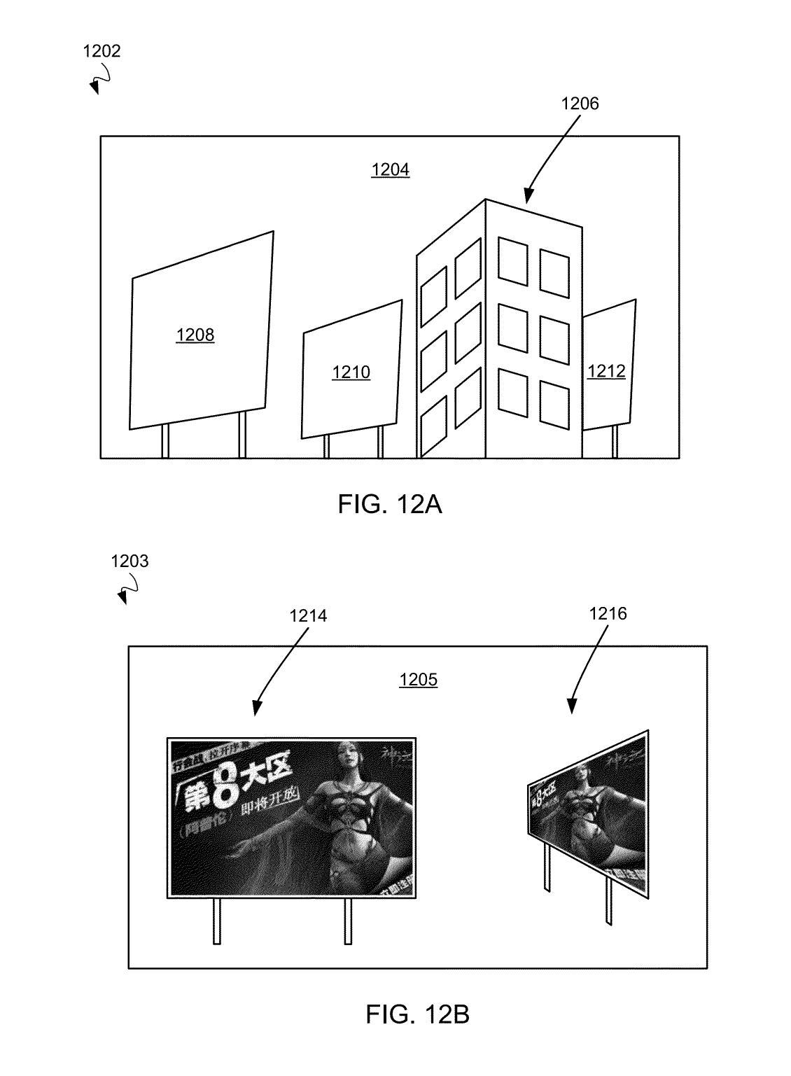

FIG. 12A depicts a video frame or screen space 1202 according to an embodiment of the present invention. A content area or world space 1204 may be used to display the content of a content, for example the play area for a video game, a scene in a movie or television show, a televised sporting event, or other media. The world space 1204 may include objects, for example, a building 1206. The world space 1204 may also include one more advertisement areas or objects, for example, billboards 1208, 1210, and 1212.

As discussed above, advertisements may be inserted into a world space. In most video games, there lacked a precise way to determine whether an advertisement was visible on the screen space. For example, a player of the game could roam around freely in the world space without ever seeing certain advertisement areas or see many advertisement areas, but there was no way to determine whether the player had seen any or how many. In other words, an advertisement that exists in a world space may not necessarily be thoroughly or completely displayed on the screen of a display. Further, if an advertisement is displayed on the screen space, the visibility of the advertisement on the screen space may vary and there lacked a precise way to determine the visibility of an advertisement on the screen space.

Embodiments of the present invention provide a graphics system, optionally in conjunction with a graphics system driver or other software, that may monitor and determine the amount of advertisement-related pixels or texels that are visible. As a result, an advertiser may be charged or billed according to the screen space visibility of an advertisement. An advertiser may be charged for advertisements inserted on areas or objects in the world space 1204 based on a variety of factors. For example, an advertiser may be charged for each time an advertisement is presented on the screen space and/or charged for the duration of presentation.

When the graphics system determines information related to the visibility of an advertisement on the screen space, it may store and accumulate the information for later use or communicate real-time such information to a commercial brokerage company for accurate and up-to-date billing of the advertiser. For example, the graphics system may communicate such information to an advertisement engine that may process the information and communicate the processed communication to the commercial brokerage company. The advertisement engine or brokerage company may also immediately determine which advertisements to provide subsequently based on the advertisement visibility information communicated by the graphics system.

In some embodiments, the billboard 1208 may appear larger or occupy more pixels on a display as compared to the billboard 1210. The billboard 1208 may be at the same distance as the billboard 1210 to a user or character's viewpoint in the world space 1204, but the billboard 1208 may appear larger since it is larger than the billboard 1210 in the world space 1204.

Alternatively, the billboard 1208 may be smaller than the billboard 1210 in the world space 1204, but the billboard 1208 may appear larger than the billboard 1210 because it is closer to a user or character's viewpoint in the world space 1204. Regardless, because the billboard 1208 occupied more area on the screen space than the billboard 1210, the advertiser of the billboard 1208 may be charged more for the appearance of their advertisement as compared to the advertiser of the billboard 1210.

In embodiments of the present invention, if an advertisement first occupies a certain amount of screen space but then later occupies more or less screen space, the advertiser may be charged based on the increased or decreased screen space occupation. For example, if an advertisement occupies half of the screen space for 3 seconds and then occupies a quarter of the screen space for 3 seconds, the advertiser may be charged less than if the advertisement occupied half of the screen space for 6 seconds total.

In various embodiments, if an advertisement is partially or completely blocked by another object because the advertisement is farther back than the object in Z-order, an advertiser may be partially charged or not charged at all. The term “Z-order” refers to the order of objects along the Z-axis. In coordinate geometry, X typically refers to the horizontal axis (left to right), Y refers to the vertical axis (up and down), and Z refers to the axis orthogonal to the other two axes (forward or backward). The Z-order information thus specifies the front-to-back ordering of objects on the screen.

For example, the billboard 1212 may be partially blocked by a building 1206 because the billboard 1212 is farther back than the building 1206 in Z-order. While the billboard 1212 may have otherwise occupied the same amount of screen space as the billboard 1210, an advertiser of the billboard 1212 may be charged less than an advertiser of the billboard 1210. If an advertisement is in the world space 1204 but not visible on the screen space because it is either blocked completely by an object, facing away from the perspective of a viewer, or in an area of the world space 1204 not being viewed, an advertiser of such an advertisement may not be charged at all.

In some embodiments, an advertiser may be charged based on the number of other advertisements in the screen space, the ratio of advertisement screen space occupied by the advertiser's advertisement compared to other advertisements, and/or the proximity of other advertisements in the screen space. For example, in the screen space 1202, there are three advertisements 1208, 1210, and 1212. Accordingly, a viewer may read, understand, recognize, or absorb any one advertisement less than if the viewer were to have been presented with one advertisement. As a result, the advertisers for each advertisement may be charged less. In one example, each advertiser may be charged a third of the amount as compared to when only one advertisement is displayed.

In another example, an advertiser may be charged less based on the ratio of advertisement screen space occupied by the advertiser's advertisement compared to other advertisements. For example, although there are three advertisements 1208, 1210, and 1212, advertisement 1208 occupies more screen space than the other advertisements 1210 and 1212, and for that reason the advertiser of advertisement 1208 may be charged more.

In yet another example, advertisers may be charged based on the proximity of other advertisements in the screen space because a viewer may read, understand, recognize, or absorb more or less of an advertisement depending on proximate advertisements. For example, if billboards 1208 and 1210 are displayed near each other, the advertisers of advertisements on these billboards may be charged less than if the billboards 1208 and 1210 were farther away from each other.

FIG. 12B depicts a video frame or screen space 1203 according to an embodiment of the present invention. In various embodiments, an advertiser may be charged differently based on the viewing angle of an advertisement. For example, if a billboard 1216 is displayed at an angle to a user or character's viewpoint in a world space 1205, a viewer of an advertisement on the billboard may have more difficulty viewing or have less exposure to the advertisement as opposed to an advertisement 1214 that appears straight on. As a result, an advertiser may be charged less depending on the angle of the advertisement.

In embodiments of the present invention, the speed or velocity of an advertisement with respect to a user or character's viewpoint in the world space 1204 may affect the amount that an advertiser is charged. If an advertisement moves very quickly in the screen space, a viewer of the advertisement may not read, understand, recognize, or absorb the advertisement as well as an advertisement that moved slowly or not at all. For example, in the video frames 1002 and 1003 of FIGS. 10A and 10B, if the character swerves to the left and right very quickly, even if the billboards or advertisements areas 1008 stay in the screen space, those areas may not be understood or absorbed by a viewer as well as an advertisement that appears but does not move in the screen space for the same amount of time. As a result, an advertiser may be charged less depending on the speed of the movement of an advertisement.

In various embodiments, the amount an advertiser is charged may be based on whether an animated advertisement completes a full cycle of the animation while on the screen space. An animated advertisement may include multiple loops, where the same animation is looped repeatedly. If a full cycle or loop of an animation is displayed in the screen space, an advertiser may be charged more than when only a partial cycle of an animation is displayed. Further, an advertiser may be charged based on the amount of full cycles of the animation are completed while on the screen space. In addition, an advertiser may be charged based on whether an animated advertisement is displayed in the screen space continuously from a beginning of the animation to an ending of the animation.

In some embodiments, an advertiser may be charged when an advertisement is interacted with, the duration of interaction, or the extent of interaction. For example, if a user clicks or taps on an advertisement, the advertiser may be charged. In another example, if a user interacts with an advertisement for longer periods of time, the advertiser may be charged additionally.

Returning to FIGS. 3A and 3B, the client device 301 or 402 may be provided to users by a service provider, for example, an Internet cafe or a video game arcade. The advertisement engine 370 may be part of a local network or may be on the cloud. In either case, the service provider may specify what advertisements the advertisement engine 370 will provide to the graphics system 330 or 430. For example, the service provider may have an account with the providers of the advertisement engine 370 and the service provider may indicate, out of all of the available advertisements, a subset of advertisements which may be provided by the advertisement engine 370.

Alternatively, instead of a subset of advertisements, the service provider may provide advertisements to the advertisement engine 370 that are custom to the service provider, e.g., the service provider may provide advertisements promoting the service provider itself. For example, an Internet cafe or arcade may provide advertisements to the advertisement engine 370 that promote its own brand, so that such advertisements may be provided to the graphics system 430. Or for example, in a retail store that provides the opportunity for a potential customer to demo a video game, the retail store may provide advertisements to the advertisement engine 370 that promote its own brand.

The service provider may provide advertisements to the advertisement engine 370 that promote products or services provided by the service provider. For example, an Internet cafe or arcade may provide advertisements related to food or drinks sold by the Internet cafe or arcade. As a result, service providers may charge advertisers for the inclusion of advertisements or may benefit from additional sales resulting from the advertising.

In various embodiments, advertisements inserted by a graphics system may be used to remedy the problem of piracy. For example, when a video game is released, it may be streamed to users instead of installed locally on their devices. For example, see copending Provisional U.S. Patent Application Ser. No. 61/647,331, “VIRTUALIZED GRAPHICS PROCESSING FOR REMOTE DISPLAY,” which is incorporated herein by reference for all purposes. Referring to FIG. 3B, a video game may be installed on the computer system 401 and may stream video frames generated by graphics system 430 to the client device 402 and ultimately to the display 450 through network 365. As a result, software pirates may encounter difficulty when attempting to pirate the video game because they do not have access to the installation of the game itself on computer system 401, but only access to a video stream.

However, if the video game is initially or later released such that it may be installed locally on devices, software pirates may pirate the video game. Once the video game is pirated, developers of the video game will experience profit declines since some users may no longer pay for the video game. To address this issue, advertisements may be used as an alternative revenue source. Advertisements may be inserted into all instances or those instances of the video game identified as being pirated. Accordingly, a developer may ultimately charge advertisers for the advertisement of their products, thereby continuing to profit from their video games.

In some embodiments, a developer may release their video game at a discounted price that is subsidized by advertisements. In other embodiments, a developer may release their video game for free that is subsidized by advertisements. Alternatively, a developer may release a fully paid version, discounted version, and/or free version of their video game that may be include more or less advertisements depending on the version of the game.

Such versions may be released during different periods. For example, a streaming version that may prevent piracy may be initially released for a period at a full price. Next, a discounted version that may be locally installed may then be released for a period at a discounted price that is subsidized by advertisements. Subsequently, a free version that may be locally installed may then be released for free that is subsidized by advertisements.

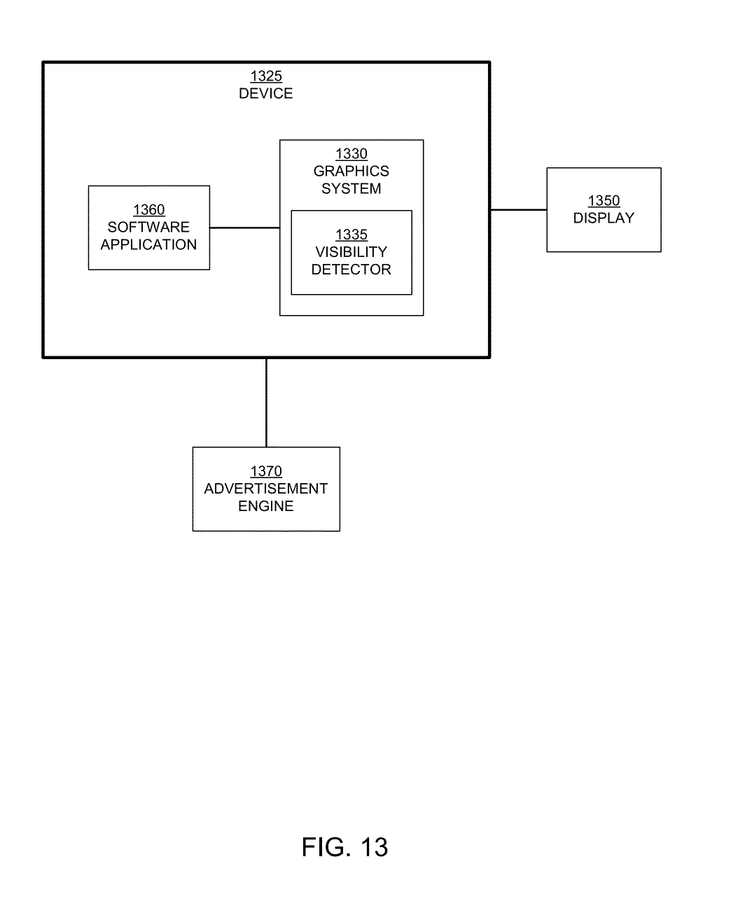

FIG. 13 is a block diagram of a system including a visibility detector 1335 and an advertisement engine 1370, according to an embodiment of the present invention. A device 1325 and the advertisement engine 1370 may be similar to the client device 301 or computer system 401 and advertisement engine 370 of FIGS. 3A and 3B, respectively. The device 1325 may execute a software application 1360 for displaying media content such as interactive media on a display 1350. The device 1325 may include a graphics system 1330 that includes a visibility detector 1335.

The visibility detector 1335 may detect portions of an advertisement in video frames representing a world space created by the graphics system 1330 by the instructions of the software application 1360. For example, the visibility detector 1335 may analyze video frames generated by the graphics system 1330 to determine how many pixels in the video frame relate to an advertisement. Alternatively, the visibility detector 1335 may analyze the world space to determine the visibility of an advertisement from the perspective of a viewer of the world space. The visibility detector 1335 may analyze the world space before or during the generation of a frame including the advertisement.

In some embodiments, the visibility detector 1335 may store and accrue visibility characteristics related to the advertisements in a video frame. In various embodiments, the visibility detector 1335 may immediately, or after storing and accruing, communicate the determined visibility characteristics to the advertisement engine 1370. The advertisement engine 1370 may use the visibility characteristics to charge an advertiser of the advertisement.

The visibility detector 1335 may be a physical component like an integrated circuit in a GPU or graphics system, or may be software like a driver that is executed by either a CPU or GPU.

FIG. 14 depicts a flowchart 1400 of an exemplary process of determining advertisement visibility, according to an embodiment of the present invention. In a block 1402, a plurality of video frames that are operable to represent a world space is generated, wherein the world space comprises an advertisement. For example, in FIGS. 12A and 12B, the world spaces 1204 and 1205 include advertisements 1208, 1210, 1212, 1214, and 1216, respectively.

In a block 1404, a visibility characteristic of the advertisement in the plurality of video frames is determined. For example, a graphics system or GPU may analyze the frames to determine how the advertisement in the world space 1204 or 1205 will be displayed on a screen space.

In various embodiments, the visibility characteristic may be based on an amount or percentage of pixels corresponding to the advertisement in the plurality of video frames. For example, referring to FIG. 12A, the visibility characteristic may be based on the amount or percentage of pixels an advertisement such as billboard 1208 occupies on the screen space 1202. In some embodiments, the visibility characteristic may be based on an amount of video frames that include pixels corresponding to the advertisement in the plurality of video frames. For example, the visibility characteristic may be based on the duration of the displaying of the billboard 1208 on the screen space 1202.

In some embodiments, the world space comprises an object that at least partially blocks the advertisement in at least one of the plurality of video frames and the visibility characteristic is based on an amount of pixels corresponding to the advertisement in the plurality of video frames. For example, still referring to FIG. 12A, the building 1206 partially blocks billboard 1212. As a result, the visibility characteristic is based on the portion of billboard 1212 that displays on the screen space 1202.

In further embodiments, the visibility characteristic is based on a viewing angle of the advertisement in the world space as represented by the plurality of video frames. For example, now referring to FIG. 12B, a billboard 1216 displayed at an angle in the screen space 1203 may correspond to a visibility characteristic different from that of the billboard 1214 that is display “straight-on.”

In various embodiments, the advertisement is animated in the world space and the visibility characteristic is based on whether the advertisement completes an animation loop in the plurality of video frames. For example, the advertisement 1214 or 1216 in world space 1205 may be animated, and the visibility characteristic may be based on whether the advertisement 1214 or 1216 completes an animation loop.

In some embodiments, there is at least one additional advertisement in the world space and plurality of video frames, and the visibility characteristic is based on the ratio of one advertisement's screen space to the other advertisements' screen space. For example, in FIG. 12A, the visibility characteristic of billboard 1208 may depend on the area of screen space it occupies in comparison to the billboards 1210 and 1212.

In further embodiments, there is at least one additional advertisement in the world space and plurality of video frames, and the visibility characteristic is based on the proximity of one advertisement on the screen space to the other advertisements on the screen space. For example, in FIG. 12A, the visibility characteristic of billboard 1208 may depend on its proximity to the billboards 1210 and 1212.

In a block 1406, the visibility characteristic is communicated to an advertisement engine. For example, in FIGS. 3A and 3B, the visibility characteristics may be communicated to the advertisement engine 370. Alternatively, the visibility characteristic may be stored. For example, the visibility characteristic may be stored locally on a client device 301 or 402 of FIGS. 3A and 3B for later retrieval. Or, the visibility characteristic may be stored on the advertisement engine 370.

In various embodiments, an advertiser is charged based on the visibility characteristic. For example, an advertiser of the advertisements 1208, 1210, 1212, 1214, or 1216 may be charged more or less based on the visibility characteristics of the advertisement.

FIG. 15 depicts a flowchart 1500 of an exemplary process of inserting advertisements, according to an embodiment of the present invention. In a block 1502, a plurality of video frames that are operable to represent a world space including an advertisement-appropriate area are generated. For example, in FIG. 5B, a video frame 503 illustrates a world space.

In a block 1504, an advertisement-appropriate area in the plurality of video frames is determined. For example, advertisement areas 508 and 510 in the video frame 503 are determined.

In a block 1506, an advertisement is inserted in the advertisement-appropriate area of the plurality of video frames and the plurality of video frames is displayed. For example, still referring to FIG. 5B, an advertisement may be inserted in advertisement areas 508 or 510. For example, an advertisement engine may indicate an advertisement to be included.

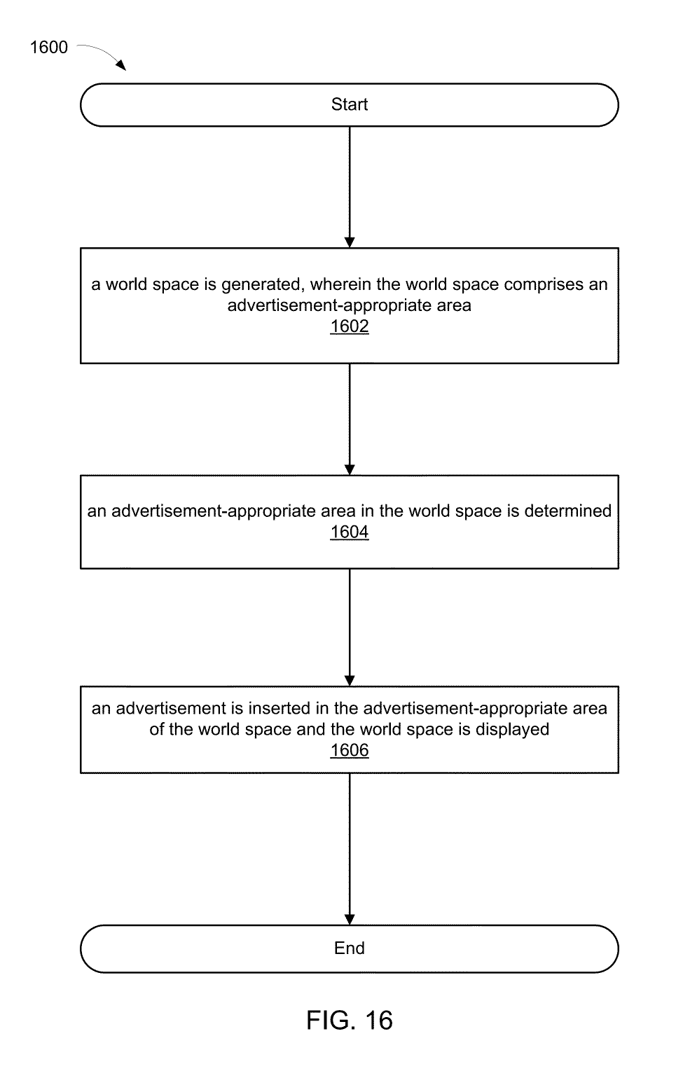

FIG. 16 depicts a flowchart 1600 of an exemplary process of inserting advertisements, according to an embodiment of the present invention. In a block 1602, a world space including an advertisement-appropriate area is generated. For example, in FIG. 10B, a video frame 1003 illustrates a world space.

In a block 1604, an advertisement-appropriate area in the world space is determined. For example, advertisement areas 1008 or 1010 in the video frame 1003 are determined.

In a block 1606, an advertisement is inserted in the advertisement-appropriate area of the world space and the world space is displayed. For example, still referring to FIG. 10B, an advertisement may be inserted in advertisement areas 1008 or 1010. For example, an advertisement engine may indicate an advertisement to be included.

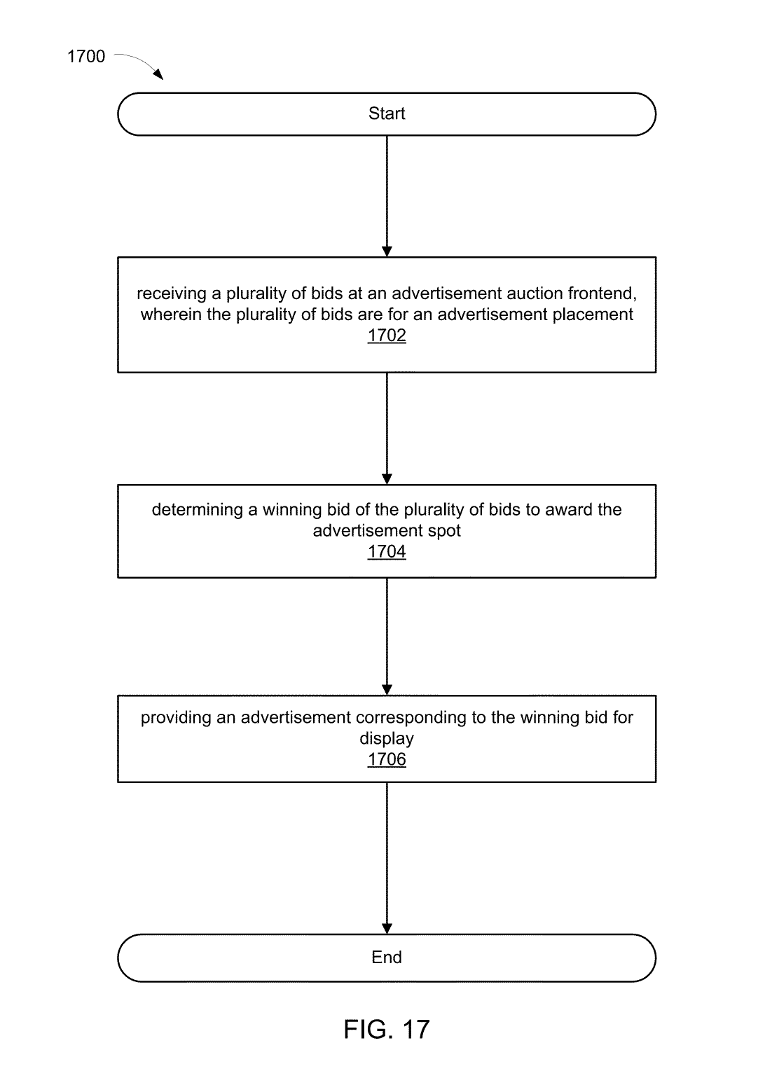

FIG. 17 depicts a flowchart 1700 of an exemplary process of providing an advertisement auction frontend, according to an embodiment of the present invention. In a block 1702, a plurality of bids at an advertisement auction frontend is received, wherein the plurality of bids are for an advertisement placement. For example, in FIG. 4, bids from bidders 380 and 382 and bidding service 384 are received at the auction frontend 474.

In a block 1704, a winning bid of the plurality of bids to award the advertisement spot is determined. For example, as discussed with relation to FIG. 4, the auction frontend 474 may choose a winning bid based on an automatic or manual bidding process. Further, the auction frontend 474 may choose a winning bid based on a variety of factors, for example, a maximum bid amount or relevancy.

In a block 1706, an advertisement corresponding to the winning bid is provided for display. For example, in FIG. 4, the auction frontend 474 and/or the advertisement may provide the advertisement corresponding to the winning bid to a graphics system for display.

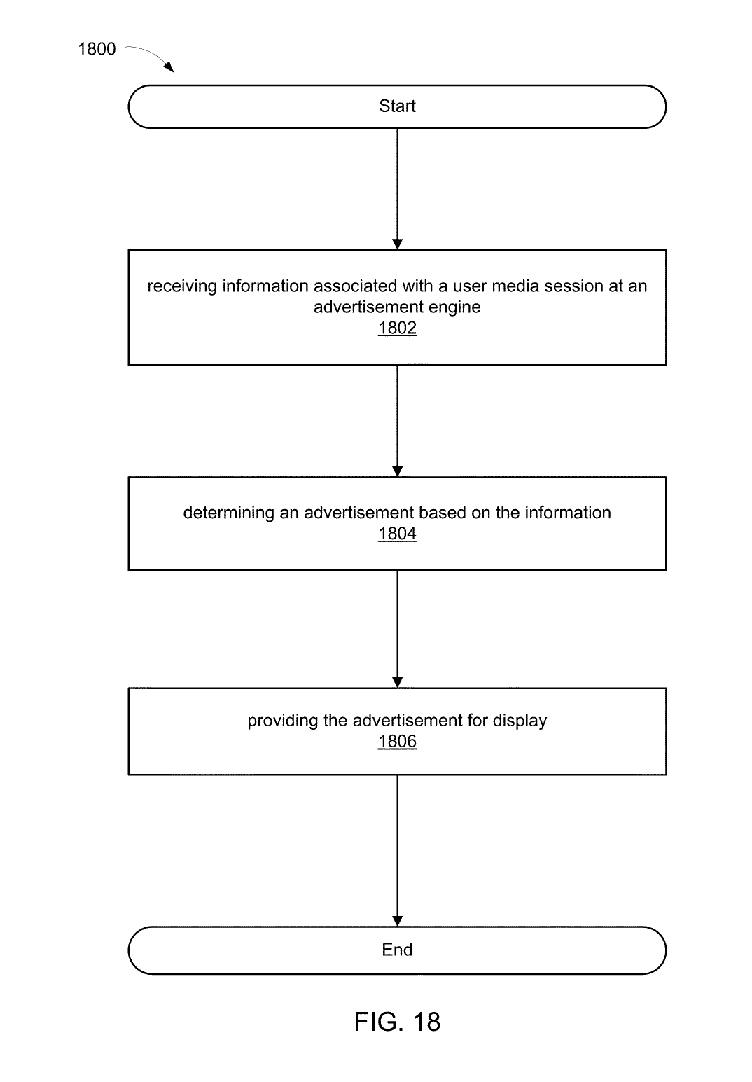

FIG. 18 depicts a flowchart 1800 of an exemplary process of providing advertisements based on rules, according to an embodiment of the present invention. In a block 1802, information associated with a user media session is received at an advertisement engine. For example, in FIG. 3A, information associated with a user's session with the software application 360 on the client device 301 may be received at the advertisement engine 370. The information may be related to a duration of gameplay, a game type, a user profile, gameplay, and so on.

In a block 1804, an advertisement is determined based on the information. For example, the advertisement engine 370 may determine that a coffee or food advertisement is appropriate if a game has been played for a long time. In another example, the advertisement engine 370 may determine that an advertisement related to auto parts is relevant when the software application 360 involves a racing video game.

In a block 1806, the advertisement is provided for display. For example, in FIG. 3A, the advertisement engine 370 provides an advertisement to the graphics system, which may then insert the advertisement into video frames that are to be displayed on display 350. FIGS. 5A, 5B, 6A, 6B, 7A, 7B, 8A, 8B, 10A, 10B, 11A, and 11B illustrate examples of advertisements that have been inserted into video frames.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. A method comprising:
in response to instructions from a software application, generating a plurality of video frames that are operable to represent a three dimensional virtual space, wherein said three dimensional virtual space comprises a shape having a surface;
applying a supplemental texture to said surface of said shape, wherein said supplemental texture is different from an original texture instructed to be applied to said surface by said software application; and
displaying said plurality of video frames, wherein said supplemental texture is rendered visible.

2. The method of claim 1, wherein said supplemental texture corresponds to an advertisement.

3. The method of claim 1, further comprising receiving said supplemental texture from an advertisement engine through a communication network.

4. The method of claim 1, wherein said three dimensional virtual space further comprises a plurality of shapes having a plurality of surfaces; and
further comprising determining said surface from among said plurality of surfaces for applying said supplemental texture.

5. The method of claim 4, wherein said determining comprises receiving information, from said software application, about which surfaces in said plurality of surfaces to apply said supplemental texture.

6. The method of claim 4, wherein said determining comprises analyzing, during a previous execution of said software application, which surfaces in said plurality of surfaces to apply said supplemental texture.

7. The method of claim 4, wherein said determining comprises analyzing, during a current execution of said software application, which surfaces in said plurality of surfaces to apply said supplemental texture.

8. The method of claim 1, wherein said applying a supplemental texture occurs using a texture mapping operation to said surface.

9. A method comprising:
in response to instructions from a software application, generating a plurality of video frames that are operable to represent a three dimensional virtual space comprising at least one shape;
including a supplemental shape in said virtual space, wherein said supplemental shape was not instructed to be included in said virtual space by said software application; and
displaying said plurality of video frames, wherein said supplemental shape is rendered visible.

10. The method of claim 9, wherein said supplemental shape corresponds to an advertisement.

11. The method of claim 9, further comprising receiving said supplemental shape from an advertisement engine through a communication network.

12. The method of claim 9, wherein said including a supplemental shape comprises replacing an original shape instructed to be included in said virtual space by said software application.

13. The method of claim 9, further comprising determining a location in said virtual space suitable for including said supplemental shape.

14. The method of claim 13, wherein said location is based on a viewer's location or perspective in said virtual space.

15. The method of claim 9, wherein said supplemental shape is received from a virtual shopping mall operable to allow users of said software application to purchase a plurality of virtual objects.

16. The method of claim 9, wherein said software application is an interactive media application.

17. A computer system comprising:
a processor;
a graphics processing system coupled to the processor and comprising a graphics processing unit (GPU);
a communication interface operable for sending and receiving data; and
memory coupled to the graphics processing system and having stored therein instructions that, if executed by the computer system, cause the computer system to execute operations comprising:
in response to instructions from a software application, generating a plurality of video frames that are operable to represent a three dimensional virtual space, wherein said three dimensional virtual space comprises a shape having a surface;
applying a supplemental texture to said surface of said shape, wherein said supplemental texture is different from an original texture instructed to be applied to said surface by said software application; and
displaying said plurality of video frames wherein said supplemental texture is rendered visible.

18. The computer system of claim 17, wherein said supplemental texture corresponds to an advertisement.

19. The computer system of claim 17, wherein said operations further comprise receiving said supplemental texture from an advertisement engine through a communication network.

20. The computer system of claim 17, wherein said three dimensional virtual space further comprises a plurality of shapes having a plurality of surfaces; and
wherein said operations further comprise determining said surface from among said plurality of surfaces for applying said supplemental texture.

21. A method of displaying advertisements, said method comprising:
accessing an advertisement;
executing a software application that is operable to generate a plurality of video frames representing a three dimensional virtual space wherein said three dimensional virtual space comprises a surface;
while said software application is executing:
replacing a texture of said surface with an advertisement texture representing said advertisement; and
using said advertisement texture, generating said plurality of video frames which comprise advertisement images corresponding to said advertisement texture applied to said surface; and
displaying said plurality of video frames comprising said advertisement images.

22. A method as described in claim 21 further comprising:
determining accounting characteristics concerning said advertisement images of said plurality of video frames; and
communicating said accounting characteristics to an advertisement engine.

23. A method as described in claim 22 wherein said determining comprises:
determining an amount of coverage of said advertisement images as a percentage of a video frame area;
determining a duration of time said advertisement images are displayed; and
determining a viewing angle of said advertisement images.

24. A method as described in claim 22 further comprising computing a net charge to an advertiser by aggregating a plurality of accounting characteristics pertaining to said advertiser.

25. A method as described in claim 22 further comprising computing a net charge to an advertiser by aggregating a plurality of accounting characteristics pertaining to said advertisement.

26. A method as described in claim 21 wherein said replacing is performed transparently to said software application.

27. A method as described in claim 21 further comprising selecting said advertisement based on subject matter content of said plurality of video frames.

28. A method as described in claim 21 further comprising selecting said advertisement based on a predetermined profile of a user of said software application.

29. A method as described in claim 21 further comprising selecting said advertisement based on a subject matter genre of said software application.

30. A method as described in claim 21 further comprising selecting said advertisement based on a type of said software application.

31. A method as described in claim 21 wherein said software application is a computer graphics based game application.
